(19) United States
(12) Patent Application Publication
(10) Pub. No.: US 2020/0337110 A1
(43) Pub. Date: Oct. 22, 2020

(54) METHOD AND APPARATUS FOR LOW POWER CONSUMPTION OPERATION OF TERMINAL IN MOBILE COMMUNICATION SYSTEM

(71) Applicant: ELECTRONICS AND TELECOMMUNICATIONS RESEARCH INSTITUTE, Daejeon (KR)

(72) Inventor: Jae Heung KIM, Daejeon (KR)

(73) Assignee: ELECTRONICS AND TELECOMMUNICATIONS RESEARCH INSTITUTE, Daejeon (KR)

(21) Appl. No.: 16/848,258

(22) Filed: Apr. 14, 2020

(30) Foreign Application Priority Data
Apr. 16, 2019 (KR) 10-2019-0044305
Apr. 19, 2019 (KR) 10-2019-0045873
May 31, 2019 (KR) 10-2019-0064589
Sep. 30, 2019 (KR) 10-2019-0121074
Mar. 23, 2020 (KR) 10-2020-0035017

(51) Int. Cl. H04W 76/28; H04W 52/02

(52) U.S. Cl. CPC H04W 76/28; H04W 52/0216

(57) ABSTRACT

An operation method of a terminal for reducing power consumption may comprise receiving, by a physical layer of the terminal, a wake-up signal (WUS) from a base station; notifying, by the physical layer of the terminal, the reception of the WUS to a medium access control (MAC) layer of the terminal; performing, by the physical layer of the terminal, a downlink physical layer monitoring operation for a preconfigured time period from a time point of the reception of the WUS; and when the preconfigured time period expires, the physical layer of the terminal stops the downlink physical layer monitoring operation.

### CROSS-REFERENCE TO RELATED APPLICATIONS

This application claims priority to Korean Patent Applications No. 10-2019-0044305 filed on Apr. 16, 2019, No. 10-2019-0045873 filed on Apr. 19, 2019, No. 10-2019-0064589 filed on May 31, 2019, No. 10-2019-0121074 filed on Sep. 30, 2019, and No. 10-2020-0035017 filed on Mar. 23, 2020 with the Korean Intellectual Property Office (KIPO), the entire contents of which are hereby incorporated by reference.

### BACKGROUND

### 1. Technical Field

The present disclosure relates generally to low power consumption operation of a terminal in a mobile communication system, and more specifically, to a method and an apparatus for low power consumption of a terminal in a mobile communication system using a high frequency band.

### 2. Related Art

In order to cope with the increase of wireless data, the mobile communication system is being considering a terminal supporting a frequency band of 6 GHz to 90 GHz for a wide system bandwidth. In the system capable of high-speed data transmission using such the wide channel bandwidth in the high-frequency region, an operation and control procedure on a radio protocol is required to reduce power consumption as the power consumption of the terminal increases.

In the conventional mobile communication system, a discontinuous reception (DRX) operation in a medium access control (MAC) layer of the terminal has been defined as a method for reducing the power consumption of the terminal. However, since the DRX operation is performed at the MAC layer of the terminal, there are a problem that the MAC layer should be activated for the DRX operation, and a problem that dynamically changing operation environments of the system and the terminal are not immediately reflected.

### SUMMARY

Accordingly, exemplary embodiments of the present disclosure provide, as an operation method of a terminal for reducing power consumption, a method of using a wake-up signal (WUS).

Accordingly, exemplary embodiments of the present disclosure provide, as an operation method of a terminal for reducing power consumption, a method of using a go-to-sleep signal (GTS).

Accordingly, exemplary embodiments of the present disclosure provide, as an operation method of a terminal for reducing power consumption, a method of changing power consumption related configuration for the terminal by transmitting preference information of the terminal to a base station.

According to an exemplary embodiment of the present disclosure, an operation method of a terminal for reducing power consumption may comprise receiving, by a physical layer of the terminal, a wake-up signal (WUS) from a base station; notifying, by the physical layer of the terminal, the reception of the WUS to a medium access control (MAC) layer of the terminal; performing, by the physical layer of the terminal, a downlink physical layer monitoring operation for a preconfigured time period from a time point of the reception of the WUS; and when the preconfigured time period expires, stopping, by the physical layer of the terminal, the downlink physical layer monitoring operation.

The WUS may be received in a slot just before an on-duration period of a discontinuous reception (DRX) operation of the terminal or at a preconfigured time point earlier by a preconfigured offset than a reference time point.

The reference time point may be a starting time point of the on-duration period, an ending time point of the on-duration period, a starting time point of a sleep time, an ending time point of the sleep time, a starting time point of a DRX cycle, or an ending time point of the DRX cycle.

The operation method may further comprise, when the WUS is not received at the preconfigured time point, stopping, by the physical layer of the terminal, the downlink physical layer monitoring operation for the preconfigured time period from the preconfigured time point.

The WUS may be transmitted in at least one subcarrier and at least one symbol, transmitted as a physical layer downlink control channel (PDCCH), or transmitted using a specific field of downlink control information (DCI) of a PDCCH.

The downlink physical layer monitoring operation performed for the preconfigured time period from the time point of the reception of the WUS may not affect a DRX operation performed in the MAC layer of the terminal.

The operation method may further comprise transmitting a response message or a signal to the base station in response to the received WUS.

The downlink physical layer monitoring operation may include a monitoring and/or reception operation for a physical layer downlink control channel (PDCCH), a control resource set (CORESET) resource, a reference signal, and a physical layer downlink shared channel (PDSCH).

According to another exemplary embodiment of the present disclosure, an operation method of a terminal for reducing power consumption may comprise receiving, by a physical layer of the terminal, a go-to-sleep signal (GTS) from a base station; notifying, by the physical layer of the terminal, the reception of the GTS to a medium access control (MAC) layer of the terminal; stopping a downlink physical layer monitoring operation for a preconfigured time period from a time point of the reception of the GTS; and when the preconfigured time period expires, releasing, by the physical layer of the terminal, the stopping of the downlink physical layer monitoring operation.

The GTS may be received in a slot just before an on-duration period of a discontinuous reception (DRX) operation of the terminal or at a preconfigured time point earlier by a preconfigured offset than a reference time point.

The reference time point may be a starting time point of the on-duration period, an ending time point of the on-duration period, a starting time point of a sleep time, an ending time point of the sleep time, a starting time point of a DRX cycle, or an ending time point of the DRX cycle.

The GTS may be transmitted in at least one subcarrier and at least one symbol, transmitted as a physical layer downlink control channel (PDCCH), or transmitted using a specific field of downlink control information (DCI) of a PDCCH.

The stopping of the downlink physical layer monitoring operation for the preconfigured time period from the time point of the reception of the GTS may not affect a DRX operation performed in the MAC layer of the terminal.

The operation method may further comprise, when the terminal transmits a scheduling request (SR) or a random access channel (RA) preamble, or when an SR/RA procedure is triggered, releasing the stopping of the downlink physical layer monitoring operation.

The operation method may further comprise transmitting a response message or a signal to the base station in response to the received GTS.

The downlink physical layer monitoring operation may include a monitoring and/or reception operation for a physical layer downlink control channel (PDCCH), a control resource set (CORESET) resource, a reference signal, and a physical layer downlink shared channel (PDSCH).

According to yet another exemplary embodiment of the present disclosure, a connection reconfiguration method of a terminal for reducing power consumption may comprise performing a discontinuous reception (DRX) operation and a measurement and reporting operation according to connection configuration received from a base station; transmitting preference information of the terminal to the base station when a predetermined condition is satisfied as a result of performing the DRX operation and the measurement and reporting operation; and receiving a connection reconfiguration indication reflecting the preference information from the base station, and performing a DRX operation and a measurement and reporting operation changed based on the connection reconfiguration indication.

The predetermined condition may include at least one of a condition that no data exchange exists with the base station for a preconfigured time and an amount of data stored in a transmission buffer is less than or equal to a reference value, a condition that a measurement or measurement reporting related event does not occur for a preconfigured time, a condition that a measured value, a measurement reporting value, or a variation thereof for a preconfigured time satisfies a preconfigured condition, a condition that a result of reporting estimation of mobility status of the terminal satisfies a mobility management change condition of the terminal, and a condition that a user requests a change through manual configuration.

The preference information may include preference for a DRX cycle that is longer or shorter than a configured DRX cycle, preference for activation or deactivation of a measurement relaxation operation, information for releasing or requesting a low latency service, information for releasing or requesting a time tolerance service, preference for deactivation or release of the DRX operation, information indicating presence or absence of an additional power supply, information indicating a battery charge state, information for requesting to switch an active bandwidth part, preference for activation or deactivation of a wake-up signal (WUS) or a go-to-sleep signal (GTS), information for requesting to change a state of the terminal, and information for requesting to change configuration of a monitored control resource set (CORESET).

The preference information may be transmitted to the base station in form of a radio resource control (RRC) layer control message, a medium access control (MAC) control element (CE), or a field parameter of a physical layer uplink control channel (PUCCH).

According to the exemplary embodiments of the present disclosure as described above, in the mobile communication system, the wake-up signal (WUS) and the go-to-sleep signal (GTS) capable of controlling a physical layer downlink monitoring operation are further defined, so that the conventional DRX operation of the MAC layer can be supplemented. Therefore, a more detailed power saving operation of the terminal becomes possible.

### BRIEF DESCRIPTION OF DRAWINGS

Exemplary embodiments of the present disclosure will become more apparent by describing in detail embodiments of the present disclosure with reference to the accompanying drawings, in which:

FIG. 1 is a conceptual diagram illustrating a first exemplary embodiment of a wireless communication network;

FIG. 2 is a block diagram illustrating a first exemplary embodiment of a communication node constituting a wireless communication network;

FIG. 3 is a state transition diagram for describing an example of state management for a terminal applied to exemplary embodiments of the present disclosure;

FIG. 4 is a conceptual diagram illustrating a DRX operation applied to exemplary embodiments of the present disclosure;

FIG. 5 is a conceptual diagram for describing an operation of a terminal based on a WUS according to an exemplary embodiment of the present disclosure;

FIG. 6 is a conceptual diagram for describing an operation of a terminal based on a GTS according to an exemplary embodiment of the present disclosure; and

FIG. 7 is a sequence chart illustrating a procedure for reconfiguring a connection with a base station for a low power consumption operation of a terminal according to an exemplary embodiment of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

While the present disclosure is susceptible to various modifications and alternative forms, specific embodiments are shown by way of example in the drawings and described in detail. It should be understood, however, that the description is not intended to limit the present disclosure to the specific embodiments, but, on the contrary, the present disclosure is to cover all modifications, equivalents, and alternatives that fall within the spirit and scope of the present disclosure.

Although the terms “first,” “second,” etc. may be used herein in reference to various elements, such elements should not be construed as limited by these terms. These terms are only used to distinguish one element from another. For example, a first element could be termed a second element, and a second element could be termed a first element, without departing from the scope of the present disclosure. The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directed coupled” to another element, there are no intervening elements.

The terminology used herein is for the purpose of describing particular embodiments only and is not intended to be limiting of embodiments of the present disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

Unless otherwise defined, all terms (including technical and scientific terms) used herein have the same meaning as commonly understood by those of ordinary skill in the art to which the present disclosure pertains. It will be further understood that terms defined in commonly used dictionaries should be interpreted as having a meaning that is consistent with their meaning in the context of the related art and will not be interpreted in an idealized or overly formal sense unless expressly so defined herein.

Hereinafter, exemplary embodiments of the present disclosure will be described in greater detail with reference to the accompanying drawings. To facilitate overall understanding of the present disclosure, like numbers refer to like elements throughout the description of the drawings, and description of the same component will not be reiterated.

A wireless communication network to which exemplary embodiments according to the present disclosure are applied will be described. The wireless communication network to which exemplary embodiments according to the present disclosure are applied is not restricted to what will be described below. That is, the exemplary embodiments according to the present disclosure may be applied to various wireless communication networks. Here, the wireless communication network may be used with the same meaning as a wireless communication system.

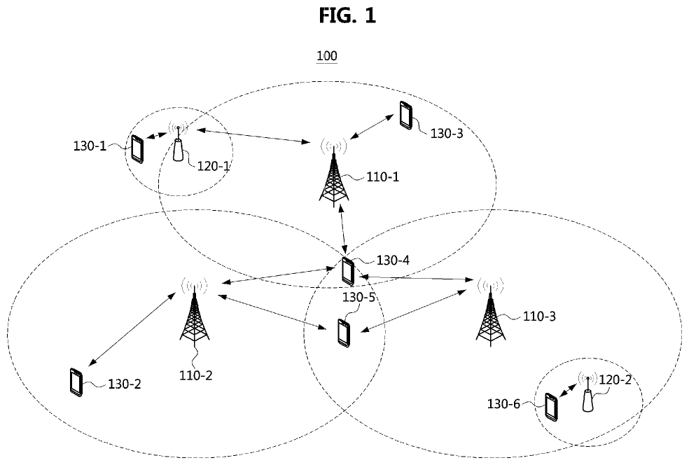

FIG. 1 is a conceptual diagram illustrating a first exemplary embodiment of a wireless communication network.

Referring to FIG. 1, a wireless communication network 100 may comprise a plurality of communication nodes 110-1, 110-2, 110-3, 120-1, 120-2, 130-1, 130-2, 130-3, 130-4, 130-5, and 130-6. Each of the plurality of communication nodes may support at least one communication protocol. For example, each of the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a space division multiple access (SDMA) based communication protocol, or the like. Each of the plurality of communication nodes may have the following structure.

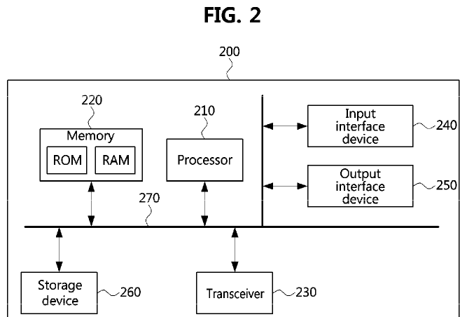

FIG. 2 is a block diagram illustrating a first exemplary embodiment of a communication node constituting a wireless communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the wireless communication network 100 may comprise a plurality of base stations 110-1, 110-2, 110-3, 120-1, and 120-2, and a plurality of user equipments (UEs) 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third UE 130-3, and the fourth UE 130-4 may belong to cell coverage of the first base station 110-1. The second UE 130-2, the fourth UE 130-4, and the fifth UE 130-5 may belong to cell coverage of the second base station 110-2. Also, the fifth base station 120-2, the fourth UE 130-4, the fifth UE 130-5, and the sixth UE 130-6 may belong to cell coverage of the third base station 110-3. The first UE 130-1 may belong to cell coverage of the fourth base station 120-1. The sixth UE 130-6 may belong to cell coverage of the fifth base station 120-2.

Here, each of the plurality of base stations 110-1, 110-2, 110-3, 120-1 and 120-2 may refer to a node B (NodeB), an evolved NodeB (eNB), a base transceiver station (BTS), a radio base station, a radio transceiver, an access point, an access node, or the like. Each of the plurality of UEs 130-1, 130-2, 130-3, 130-4, 130-5 and 130-6 may refer to a terminal, an access terminal, a mobile terminal, a station, a subscriber station, a mobile station, a portable subscriber station, a node, a device, or the like.

Each of the plurality of communication nodes 110-1, 110-2, 110-3, 120-1, 120-2, 130-1, 130-2, 130-3, 130-4, 130-5, and 130-6 may support a cellular communication (e.g., long term evolution (LTE), LTE-A (advanced), etc. defined in the 3rd generation partnership project (3GPP) standard), or wireless protocol specifications of mmWave (e.g., 6 GHz to 80 GHz band) based wireless access technology. Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network (not shown) through the ideal or non-ideal backhaul. Each of the plurality of base stations 110-1, 110-2, 110-3, 120-1, and 120-2 may transmit a signal received from the core network to the corresponding UE 130-1, 130-2, 130-3, 130-4, 130-5, or 130-6, and transmit a signal received from the corresponding UE 130-1, 130-2, 130-3, 130-4, 130-5, or 130-6 to the core network.

In addition, each of the plurality of base stations 110-1, 110-2, 110-3, 120-1, 120-2, 310, 330, 471, and 472 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communication (or, proximity services (ProSe)), or the like. Here, each of the plurality of UEs 130-1, 130-2, 130-3, 130-4, 130-5, 130-6, 410-1, 410-2, 410-3, and 410-4 may perform operations corresponding to the operations of the plurality of base stations 110-1, 110-2, 110-3, 120-1, and 120-2, and operations supported by the plurality of base stations 110-1, 110-2, 110-3, 120-1, 120-2, 310, 330, 431-3, and 431-4. For example, the second base station 110-2 may transmit a signal to the fourth UE 130-4 in the SU-MIMO manner, and the fourth UE 130-4 may receive the signal from the second base station 110-2 in the SU-MIMO manner. Alternatively, the second base station 110-2 may transmit a signal to the fourth UE 130-4 and fifth UE 130-5 in the MU-MIMO manner, and each of the fourth UE 130-4 and fifth UE 130-5 may receive the signal from the second base station 110-2 in the MU-MIMO manner. Each of the first base station 110-1, the second base station 110-2, and the third base station 110-3 may transmit a signal to the fourth UE 130-4 in the CoMP transmission manner, and the fourth UE 130-4 may receive the signal from the first base station 110-1, the second base station 110-2, and the third base station 110-3 in the CoMP manner. Each of the plurality of base stations 110-1, 110-2, 110-3, 120-1, and 120-2 may exchange signals with the corresponding UEs 130-1, 130-2, 130-3, 130-4, 130-5, or 130-6 which belongs to its cell coverage in the CA manner. Each of the base stations 110-1, 110-2, and 110-3 may coordinate D2D communications between the fourth UE 130-4 and the fifth UE 130-5, and thus the fourth UE 130-4 and the fifth UE 130-5 may perform the D2D communications or Vehicle-to-Everything (V2X) services under coordination of each of the second base station 110-2 and the third base station 110-3.

Hereinafter, operation methods of communication nodes in a wireless communication network will be described. Even when a method (e.g., transmission or reception of a signal) to be performed in a first communication node among communication nodes is described, a corresponding second communication node may perform a method (e.g., reception or transmission of the signal) corresponding to the method performed in the first communication node. That is, when an operation of a terminal is described, a corresponding base station may perform an operation corresponding to the operation of the terminal. Conversely, when an operation of the base station is described, the corresponding terminal may perform an operation corresponding to the operation of the base station.

In the following description, the SGW is a termination node of a core network for exchanging data packets with a base station providing services to a user terminal using a radio access protocol. Also, the MME is an entity in charge of a control function in a radio access section (or interface) for user terminals in a wireless communication network. Thus, in the following description, the present disclosure is not limited to the specific term ‘SGW’ or ‘MME’. That is, the above-described terms may be replaced with other terms indicating a function that supports a radio access protocol according to a radio access technology (RAT) or an entity that performs the corresponding function according to a configuration of the core network.

When a dual connectivity function is supported, the terminal may configure connections with a plurality of base stations and receive services from the plurality of connected base stations. According to roles of the base stations supporting the dual connectivity function for the terminal, the base stations may be classified into a master base station and a secondary base station(s). Hereinafter, ‘dual connectivity’ may include dual connectivity using multiple base stations using the same radio access technology (RAT) and dual connectivity using multiple base stations using different RATs (e.g., MR-DC: Multi-Radio Dual Connectivity).

Here, the master base station (or node) may refer to a node that mainly performs a radio resource control (RRC) function and supports a control plane connection function with a core network in order to support the dual connectivity function. The master node may be composed of a plurality of cells, and the plurality of cells constituting the master node may be referred to as a ‘master cell group (MCG)’. A MCG bearer means a bearer that follows only the logical channel configuration of radio link control (RLC) and MAC layers of the cell belonging to the MCG.

In addition, the secondary base station (or node) may refer to a node that does not support a control plane connection function with the core network, and provides a service by using additional radio resources to the terminal in order to support the dual connectivity function. The secondary node may be composed of a plurality of cells, and the plurality of cells constituting the secondary node may be referred to as a ‘secondary cell group (SCG)’. The SCG bearer means a bearer that follows only the logical channel configuration of RLC and MAC layer of the cell belonging to the SCG.

Meanwhile, a split bearer may be a bearer that uses both the logical channel configurations of the MAC and RLC layers of the MCG and SCG. The split bearer may be classified into a secondary node (SN) terminated bearer or a master node (MN) terminated bearer according to the type of node performing a packet data convergence protocol (PDCP) function. The MN terminated bearer is a bearer in which the PDCP function for the corresponding bearer is performed in the master node, and the SN terminated bearer is a bearer in which the PDCP function for the corresponding bearer is performed in the secondary node.

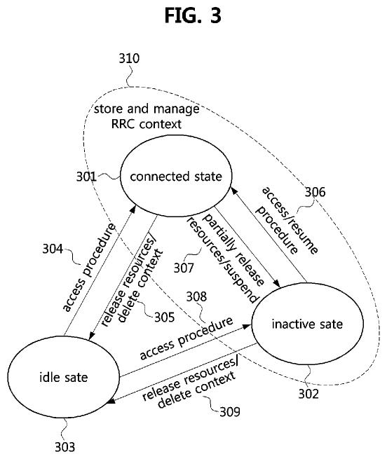

FIG. 3 is a state transition diagram for describing an example of state management for a terminal applied to exemplary embodiments of the present disclosure.

The terminal may operate in a connected state 301, an inactive state 302, or an idle state 303 according to a connection configuration state with the base station providing services. The terminal in the connected state 301 and the inactive state 302 may store and manage RRC context information together with the base station (310). When the terminal transitions to the idle state 303 through a procedure 305 or 309, the RRC context information may be deleted. Here, the RRC context information may include an identifier assigned to the corresponding terminal, and may additionally include parameters configured for protocol data unit (PDU) session information, security key, capability information, and the like.

The terminal in the idle state 303 may monitor a downlink signal or perform a measurement operation in an on-duration period or an active time according to a discontinuous reception (DRX) cycle configured for a low power consumption operation, so as to perform a cell selection or reselection operation to camp on an optimal base station (or, cell). The terminal may acquire system information to camp on a new cell. The terminal may request required system information when necessary. In addition, the terminal may perform an operation for receiving a downlink paging message in the on-duration period or the active time according to configured paging occasions.

The terminal in the connected state 301 may establish a radio bearer (e.g., a data radio bearer (DRB) or a signal radio bearer (SRB)) with the serving cell (or base station) and store and manage RRC context information required in the connected state. The terminal in the connected state may monitor a physical downlink control channel (PDCCH) by using the stored and managed RRC context information and connection configuration information from the base station, and receive a downlink packet scheduled and transmitted by the serving cell or transmit a packet to the serving cell by using uplink grant information. The mobility function for the terminal in the connected state 301 may be performed through a handover procedure when the cell is changed. For such the handover procedure, the terminal may perform a measurement operation on the serving cell or neighbor cells according to measurement or reporting parameters configured by the serving cell, and report the result to the serving cell. In addition, the terminal in the connection state 301 may perform the DRX operation according to DRX operation configuration parameters for the connection state configured by the serving cell. The terminal in the connected state 301 performing the DRX operation may perform a PDCCH monitoring operation in the on-duration period or the active time according to the DRX cycle.

The terminal in the inactive state 302 may store and manage RRC context information required in the inactive state. The terminal in the inactive state 302 or the idle state 303 may perform the DRX operation according to the DRX parameters configured by the last serving cell. Depending on the DRX cycle, the terminal may perform a cell selection or reselection operation for camping on an optimal base station (or cell) by monitoring a downlink signal or performing a measurement operation in the on-duration period or the active time. The terminal may acquire system information to camp on a new cell. The terminal may request required system information when necessary. In addition, the terminal in the inactive state or the idle state may perform an operation for receiving a downlink paging message in the on-duration period or the active time according to configured paging occasions.

A beamforming technique may be applied for transmission and reception through a radio link between the base station (or cell) and the terminal. A signal transmitted by the terminal may be used to provide mobility between base stations or to select an optimal beam within the base station. The terminal may be provided with services by establishing a connection(s) with one or more cells (or base stations). Alternatively, the terminal may exist in a service area of the corresponding base station in a state in which only connection configuration is maintained (e.g., state in which access stratum (AS) context information is stored and managed) or in a state in which the terminal does not have connection configuration.

In the mobile communication system using the base station to which the beamforming technique is applied in a high frequency band, a beam level mobility support function that changes a configured beam of the terminal within the base station, and a mobility support and radio resource management function that changes the configured beam and radio link configuration between base stations (or cells) may be considered.

In order to perform the mobility support and radio resource management function, the base station may transmit a synchronization signal or a reference signal for the terminal to search or monitor. In case of a base station using a frame format supporting a plurality of symbol lengths to support multi-numerology, monitoring by the terminal may be performed for a synchronization signal or a reference signal configured with an initial numerology, default numerology, or default symbol length.

Here, the initial numerology or the default numerology may be a configuration of a frame format applied to radio resources in which a UE-common search space is configured, a frame format applied to radio resources in which a control resource set (CORESET) ZERO (or, CORESET #0) of physical downlink control channels of the 3GPP new radio access technology (New RAT, NR) system is configured, or a frame format applied to radio resources through which a synchronization symbol burst for identifying a cell in the 3GPP NR system is transmitted.

Here, the frame format may refer to information on configuration parameters (e.g., values of the configuration parameters, offset, index, identifier, range, periodicity, or interval (or, duration), etc.) such as a subcarrier spacing (SCS) configuring a radio frame (or subframe), a control channel configuration (e.g., configuration of CORESET), a symbol (or slot) configuration, a reference signal configuration, or the like. The information on the frame format may be transferred to the terminal using system information or a dedicated control message.

In addition, the terminal, which has configured a connection with the base station, may perform a beam management operation by monitoring a configured beam or an activated beam through transmission of an uplink dedicated reference signal configured by the base station or reception of a downlink dedicated reference signal configured by the base station.

For example, the base station may transmit a synchronization signal (SS) and/or a downlink reference signal so that terminals in its service coverage can search for itself to perform downlink synchronization maintenance, beam configuration, or radio link monitoring operations. Also, the terminal, which has configured a connection with the serving base station, may receive physical layer radio resource configuration information for connection configuration and radio resource management from the serving base station.

Here, the physical layer radio resource configuration information may mean configuration parameters in RRC control messages of the LTE or NR system, such as PhysicalConfigDedicated, PhysicalCellGroupConfig, PDCCH-Config, PDCCH-ConfigSIB1, ConfigCommon, PUCCH-Config, RACH-ConfigCommon, RACH-ConfigDedicated, RadioResourceConfigCommon, RadioResourceConfigDedicated, ServingCellConfig, ServingCellConfigCommon, or the like, and may include the following information. The configuration information may include parameter values such as a configuration (or allocation) periodicity of a corresponding signal (or radio resource) based on a frame format of a base station (or transmission frequency), position information of a radio resource for transmission in a time domain/frequency domain, a transmission (or allocation) time, or the like. Here, the frame format of the base station (or transmission frequency) may mean a frame format having a plurality of symbol lengths according to a plurality of SCS within one radio frame to support multi-numerology. That is, the number of symbols constituting minislots, slots, and subframes that exist within one radio frame (e.g., a frame of 10 ms) may be configured differently.

(1) Configuration information of transmission frequency and frame format of base station
Transmission frequency information: information on all transmission carriers (i.e., cell-specific transmission frequency) in the base station, information on BWPs in the base station, information on a transmission time reference or time difference between transmission frequencies in the base station (e.g., transmission periodicity or offset parameter indicating the transmission reference time (or time difference) of the synchronization signal), etc.
Frame format information: configuration parameters of a mini-slot, slot, subframe that supports a plurality of symbol lengths according to SCS.

(2) Configuration information of downlink reference signal (e.g., channel state information-reference signal (CSI-RS), common reference signal (Common-RS), etc.)
Configuration parameters such as a transmission periodicity, a transmission position, a code sequence, or a masking (or scrambling) sequence for a reference signal commonly applied in the coverage of the base station (or beam).

(3) Configuration information of uplink control signal
Configuration parameters such as a sounding reference signal (SRS), uplink beam sweeping (or beam monitoring) reference signal (RS), uplink grant-free radio resources, or uplink radio resources (or RA preamble) for random access, etc.

(4) Configuration information of physical downlink control channel (PDCCH)
Configuration parameters such as a reference signal for PDCCH demodulation, a beam common reference signal (e.g., a reference signal that can be received by all terminals in a beam coverage), a beam sweeping (or beam monitoring) reference signal, a reference signal for channel estimation, etc.

(5) Configuration information of physical uplink control channel (PUCCH)

(6) Scheduling request signal configuration information

(7) Configuration information for a feedback (ACK or NACK) transmission resource for supporting HARQ functions, etc.

(8) Number of antenna ports, antenna array information, beam configuration or beam index mapping information for application of beamforming techniques

(9) Configuration information of downlink and/or uplink signals (or uplink access channel resource) for beam sweeping (or beam monitoring)

(10) Configuration information of parameters for beam configuration, beam recovery, beam reconfiguration, or radio link re-establishment operation, a beam change operation within the same base station, a reception signal of a beam triggering handover execution to another base station, timers controlling the above-described operations, etc.

In case of a radio frame format that supports a plurality of symbol lengths for supporting multi-numerology, the configuration (or allocation) periodicity of the parameter constituting the above-described information, the time-domain and frequency-domain position information of the radio resource, or the transmission (or allocation) time may be information configured for each corresponding symbol length (or subcarrier spacing).

In the following description, ‘Resource-Config information’ may refer to a control message for radio resource configuration including at least one parameter among the above-described physical layer radio resource configuration information. In the following description, a property or setting value (or range) of an information element (or parameter) transmitted by the corresponding control message may have a meaning, rather than the name of ‘Resource-Config information’. Thus, the information element (or parameter) conveyed by the Resource-Config control message may be radio resource configuration information which is commonly applied to the entire base station (or beam) coverage or dedicatedly allocated to a specific terminal (or terminal group). The configuration information of the above-described Resource-Config information may be configured as one control message or may be configured as different control messages according to the property of the configuration information. In addition, the beam index may be represented without distinction between transmission beam indexes and reception beam indexes by using an index (or identifier) of a reference signal mapped or associated with the corresponding beam, or an index (or identifier) of a transmission configuration indicator (TCI) state for beam management.

Therefore, the terminal in the connected state may be provided with services through a beam configured with the base station. For example, when the beam #3 of the base station and the beam #2 of the terminal are configured (or beam paired) for the terminal to receive services, the terminal may search or monitor a downlink radio channel by using a downlink synchronization signal (e.g., a synchronization signal block (SSB) of the 3GPP NR system) and a downlink reference signal (e.g., CSI-RS of the NR system) of the beam #3 of the base station. Here, that the beams are configured (or beam paired) and services are provided may mean that packets are transmitted or received through an activated beam among one or more configured beams. In the 3GPP NR system, activation of a beam may mean that a configured TCI state is activated.

In addition, when the terminal is in an idle state or an inactive state, the terminal may search for or monitor a downlink radio channel using parameters obtained or configured from the system information or common Resource-Config information. Further, the terminal may attempt access or transmit control information using an uplink channel (e.g., a random access channel or a physical layer uplink control channel).

Through such the radio link monitoring (RLM) operation, the terminal may detect a radio link problem. Here, the detection of a radio link problem means that there is an error in configuring or maintaining physical layer synchronization for the corresponding radio link. That is, this means that it is detected that the physical layer synchronization of the terminal has not been maintained for a certain time. When a radio link problem is detected, a radio link recovery operation may be performed. If the radio link problem is not recovered, a radio link failure (RLF) may be declared, and a radio link re-establishment procedure may be performed.

A physical layer (Layer 1 or physical layer), Layer 2 functions such as Medium Access Control (MAC), Radio Link Control (RLC), Packet Data Convergence Protocol (PDCP), etc., or Layer 3 functions such as Radio Resource Control (RRC) of the radio protocol constituting the radio link may participate in the procedures such as the detection of a physical layer problem in a radio link, the radio link recovery, the radio link failure detection (or declaration), and the radio link re-establishment according to the radio link monitoring operation.

The physical layer of the terminal may receive a downlink synchronization signal and/or a reference signal (RS) to monitor the radio link. In this case, the reference signal may be a base station common reference signal (Common RS) or a beam common reference signal, or a dedicated reference signal allocated to the terminal (or terminal group). Here, the common reference signal refers to a reference signal that can be received by all terminals within the coverage (or service area) of the corresponding base station or beam to estimate a channel. In addition, the dedicated reference signal refers to a reference signal that can be received and used for channel estimation only by a specific terminal or terminal group within the coverage of the base station or the beam.

Therefore, when the base station or the configured beam is changed, the dedicated reference signal for managing the changed beam may be changed. This means that a procedure for selecting another beam from among the beams configured through the configuration parameters between the base station and the terminal or changing the configured beam is required. In the 3GPP-based NR system, changing the beam means that an index of another TCI state is selected among the indexes (or identifiers) of the configured TCI states or a new TCI state is configured and changed to an active state. Configuration information on the common reference signal may be obtained by the terminal through system information. Alternatively, in case of a handover in which the base station is changed or in case of connection reconfiguration, the base station may transmit the configuration information on the common reference signal to the terminal through a dedicated control message.

According to configuration conditions of the radio protocol layers of the base station (or cell), information for identifying the corresponding transmitting base station may be transferred to the terminal by using a control message of the RRC layer or the MAC layer, or a physical layer control channel. In this case, the information for identifying the transmitting base station (or transmission node) may include an identifier of the base station (or transmission node), reference signal information, information on a configured beam (or configured TCI state), information on a sequence (or scrambling) identifier for the base station (or transmission node), or the like.

The reference signal information may be a radio resource of a reference signal allocated for each transmitting base station, sequence information or index information of the reference signal, or sequence information or index information of a dedicated reference signal allocated to the terminal. Here, the radio resource of the reference signal may mean parameters indicating a symbol position on a time axis at which the reference signal is transmitted and a relative or absolute subcarrier position on a frequency axis within a radio resource region such as a frame, subframe, or slot. Such the parameter may be represented by a number or the like sequentially assigned to index, symbol, or subcarrier, which represents a corresponding radio resource element or radio resource set. Hereinafter, the reference signal information may refer to the above-described transmission periodicity, the code sequence or masking (or scrambling) of the reference signal, the radio resource of the reference signal, index information, or the like. The reference signal identifier may refer to a parameter (e.g., resource ID, resource set ID) that can distinguish the corresponding reference signal information uniquely among one or more reference signal information.

The information on the configured beam may be an index (or identifier) of the configured beam (or configured TCI state), configuration information of the corresponding beam (e.g., transmission power, beam width, vertical/horizontal angle, etc.), transmission or reception timing information (e.g., an index or an offset value of subframe, slot, mini-slot, symbol, etc.) of the corresponding beam, or reference signal information or reference signal identifier information corresponding to the corresponding beam.

In addition, the base station may be installed in the air such as a drone, an aircraft, or a satellite to perform the operation of the base station described in the present disclosure.

Accordingly, the terminal may identify a target base station (or transmission node) to perform a beam monitoring operation, a radio access operation, or a transmission/reception operation of a control (or data) packet by using identification information of the transmitting base station (or transmission node), which the base station transmits using the control message of the RRC layer or the MAC layer, or the physical layer control channel

In addition, where a plurality of beams are configured to the terminal, the base station and the terminal may transmit and receive packet information with all the configured beams, and the number of downlink beams may be the same as or different from the number of uplink beams. For example, a plurality of downlink beams from the base station to the terminal may be configured, and one uplink beam from the terminal to the base station may be configured.

Alternatively, when a plurality of beams are configured, the base station and the terminal may not transmit and receive packet information with all the configured beams, and some of the configured plurality of beams may be configured as reserved (or candidate) beam(s) not for transmitting and receiving packet information. For example, the configured plurality of beams may be configured in form of primary beam, secondary beam, or reserved (or candidate) beam(s). In the NR system, such the configuration of the plurality of beams may mean that the configured TCI state identifiers (IDs) are configured in form of primary, secondary, or reserved.

For example, the primary beam (e.g., primary TCI state ID) may mean a beam capable of transmitting and receiving data and control signaling, and the secondary beam (e.g., secondary TCI state ID or deactivated TCI state ID) may mean a beam capable of transmitting and receiving only data packets excluding control signaling. Here, the exclusion of the control signaling may be performed by a method of restricting the control signaling of physical layer, layer 2 (e.g., layer 2 such as MAC, RLC, PDCP, etc.), or layer 3 (e.g., layer 3 such as RRC, etc.) according to each layer, a method of partially restricting them according to functions within the layer, or a method of restricting them according to the type of the control message. However, the type of control message may mean a type of control message generated or transmitted/received according to operational functions of the radio protocol such as discontinuous transmission/reception (DRX/DTX) operations, retransmission operations, connection configuration and management operations, measurement/reporting operations, operations of a paging procedure, operations of an access procedure, etc.

In addition, the reserved (or candidate) beam (e.g., reserved TCI sate ID or deactivated TCI state ID) may be limited in transmission and reception of data or signaling packets. Also, the reserved (or candidate) beam may be configured as a beam on which the base station or the terminal performs only beam monitoring operations for beam matching (or configuration) or performs only measurement and reporting operations. Accordingly, measurement results for the reserved (or candidate) beam may be reported using the primary beam or the secondary beam. The measurement or reporting on the reserved (or candidate) beam may be performed in accordance with a related configuration parameter or periodically or aperiodically in accordance with a determination or event condition of the terminal. In particular, the report of the results of measurement or beam monitoring on the reserved (or candidate) beam may be transmitted using a physical layer control channel, such as a physical uplink control channel (PUCCH) of the LTE (or NR) system, or a control message of the MAC layer (e.g., a form such as MAC control PDU). Here, the result of the beam monitoring may refer to measurement results of one or more beams (or beam groups) as results of the beam monitoring (or beam sweeping) operation on the formed beam of the base station, which is performed by the terminal.

Based on the report of results of beam measurement or beam monitoring, the base station may change the property (e.g., primary beam, secondary beam, reserved (or candidate) beam, active beam, or deactivated beam) of the beam (or property of the TCI state). Here, when the TCI state is changed, the property of the TCI state may be changed to a primary TCI state, a secondary TCI state, a reserved (or candidate) TCI state, a configured TCI state, an active TCI state, a deactivated TCI state, or the like.

As described above with respect to the property of the TCI state, a state in which a data packet or control signaling can be transmitted or received even in a limited manner, such as the primary TCI state or the secondary TCI state, may be assumed as the active TCI state or a serving TCI state. Also, a state in which it is a target of measurement or management, but data packets or control signaling cannot be transmitted or received, such as the reserved (or candidate) TCI state, may be assumed as the deactivated TCI state or configured TCI state.

The change of the property of the beam (or TCI state) may be controlled at the RRC layer or the MAC layer. When changing the property of the beam (or TCI state) at the MAC layer, the MAC layer may notify the higher layer of the beam property change. In addition, the change of beam property may be transferred to the terminal using a control message of the MAC layer or a physical layer control channel (e.g., a physical downlink control channel (PDCCH) of the LTE (or NR) system). Here, when the physical layer control channel is used, the control information may be configured in form of downlink control information (DCI), uplink control information (UCI), or a separate indicator (or field information) of the LTE (or NR) system.

The terminal may request to change the TCI state property based on the beam measurement or monitoring results. The control information or feedback information for requesting the change of the TCI state property may be transmitted using a physical layer control channel, a MAC layer control message, or an RRC control message. The control message, signaling information, or feedback information for changing the TCI state property may be configured using at least one or more parameters from the above-described information on configured beam.

The property change of the beam (or TCI state) described above may mean a change from the active beam to the deactivated beam or reserved (or candidate) beam, or a change from the primary beam to the secondary beam or reserved (or candidate) beam, or vice versa. That is, it means that the property of the beam is changed between the beam properties described above, and the change of beam property may be performed in the RRC layer or the MAC layer. If necessary, the beam property change may be performed through partial cooperation between the RRC layer and the MAC layer.

In addition, when a plurality of beams are allocated, a beam for transmitting a physical layer control channel may be configured and operated. That is, a physical layer control channel may be transmitted using all the multiple beams (e.g., the primary beam or the secondary beam) or a physical layer control channel may be transmitted using only the primary beam.

Here, the physical layer control channel is a channel such as PDCCH or PUCCH of the LTE (or NR) system, and may transmit scheduling information including radio resource element (RE) allocation and modulation and coding scheme (MCS) information, channel quality indication (CQI), preceding matrix indicator (PMI), feedback information such as HARQ ACK/NACK, resource request information such as scheduling request (SR), beam monitoring result (or TCI state ID) for supporting beamforming function, measurement information on active or inactive beams, or the like.

In the above description, the radio resource may be configured by frequency-axis parameters such as center frequency, system bandwidth, subcarriers, or the like and time-axis parameters according to a unit of transmission (or reception) time (or, periodicity, interval, window) such as radio frame, subframe, transmission time interval (TTI), slot, mini-slot, symbol, or the like. Additionally, the radio resource may refer to a resource occupied for transmission in the radio section by applying a hopping pattern of the radio resource, a beam forming technique using multiple antennas (e.g., beam configuration information, beam index), or a code sequence (or bit sequence or signal sequence). In case of such the radio resource, the name of the physical layer channel (or transport channel) may vary according to the type (or property) of data or control message to be transmitted, uplink, downlink, sidelink (or side channel), or the like.

Such the reference signal for beam (or TCI state) or radio link management may include a synchronization signal such as a synchronization signal (SS) or a synchronization signal block (SSB), a channel state information reference signal (CSI-RS), a phase tracking (PT-RS), a sounding reference signal (SRS), a demodulation reference signal (DM-RS), or the like. A reference parameter for reception quality of the reference signal for beam (or TCI state) or radio link management may be configured as a parameter such as a measurement unit time, a measurement interval, a reference value indicating a degree of improved change, a reference value indicating a degree of deteriorated change, or the like. The measurement unit time or measurement interval may be configured as an absolute time reference (e.g., ms, sec, etc.), transmission timing interval (TTI), a radio channel configuration such as symbol, slot, (sub)frame, scheduling periodicity, etc., an operation periodicity of the base station or terminal, or the like. Also, the reference value representing the degree of change in reception quality may be configured as an absolute value (dBm) or a relative value (dB). Also, the reception quality of the reference signal for beam (or TCI state) or radio link management may be represented by Reference Signal Received Power (RSRP), Reference Signal Received Quality (RSRQ), Received Signal Strength Indicator (RSSI), Signal-to-Noise Ratio (SNR), Signal-to-Interference Ratio (SIR), or the like.

Meanwhile, in the 3GPP NR system using the millimeter frequency band, a bandwidth part (BWP) concept is applied to secure flexibility of operating a channel bandwidth for packet transmission. The base station may configure up to four BWPs having different bandwidths to the terminal. The BWPs may be configured independently for downlink and uplink. Each BWP may have not only a different bandwidth but also a different subcarrier spacing (SCS).

For example, the terminal in the connected state 301 described in FIG. 3 may measure signal qualities of radio links for the serving cell or cells that are measurement objects (e.g., neighbor cell, target cell, candidate cell, and the like) based on synchronization signal/physical broadcast channel (SS/PBCH) blocks or CSI-RS. Here, the signal quality may be expressed by RSRP, RSRQ, RSSI, SNR, SIR, or SINR, which are referred to as the reception performance of the reference signal for radio link management or the beam (or TCI state) described above.

In addition, the terminal in the inactive state 302 or the idle state 303 of FIG. 3 may measure signal qualities (e.g., RSRP, RSRQ, SINR, RSSI, or the like) of radio links for the serving cell (or camped cell) or neighbor cells according to a configured DRX cycle (e.g., measurement cycle) based on the SS/PBCH blocks. The terminal may perform a cell selection or reselection operation based on the measurement result. For the measurement on the serving cell (or camped cell), the terminal may obtain, through system information of the corresponding cell, information on a transmission periodicity (e.g., ssb-PeriodicityServingCell information) of the acquired SS/PBCH block or configuration information (e.g., ssb-PositionslnBurst information) of radio resources through which the SS/PBCH block is transmitted. In addition, for the measurement on the neighbor cells, the terminal may acquire signal measurement time configuration (SMTC) window information through the system information. When the terminal in the inactive state 302 or the idle state 303 performs the cell selection or reselection operation based on the measurement of the SS/PBCH blocks, if a change in a radio access network (RAN) area or a tracking area (TA) is recognized, the terminal may perform a RAN area or tracking area update procedure.

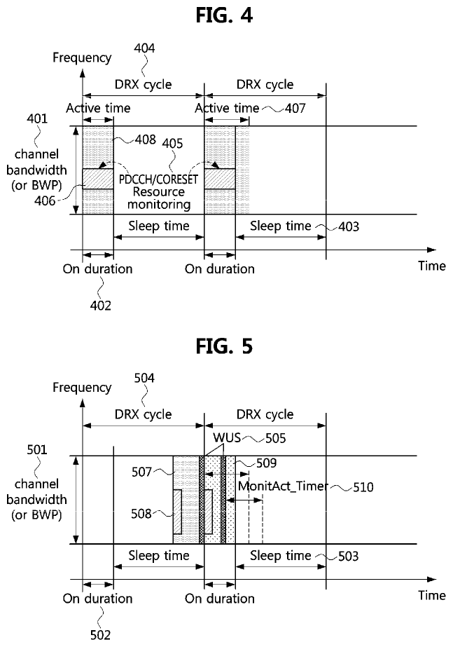

As described above, the terminal may perform a DRX operation intermittently monitoring a downlink channel according to a configured DRX cycle to reduce power consumption. DRX parameters including the DRX cycle may be configured to be different values according to the above-described state of the terminal (e.g., state 301, 302, or 303 of FIG. 3). The basic DRX operation of the terminal will be described with reference to FIG. 4.

FIG. 4 is a conceptual diagram illustrating a DRX operation applied to exemplary embodiments of the present disclosure.

Referring to FIG. 4, the terminal may perform a DRX operation for low power consumption according to a DRX cycle 404 composed of an on-duration period 402 and a sleep time 403. The terminal may monitor a physical layer downlink control channel (e.g., physical downlink control channel (PDCCH)) or a control resource set (CORESET) 406 within a channel bandwidth (or bandwidth part (BWP)) during the on-duration period. When it is determined through the monitoring operation 405 on the PDCCH or the CORESET that downlink reception indication information or scheduling information for uplink transmission for the corresponding terminal is not received in the on-duration period, the terminal may enter the sleep time 403 at the end of the on-duration period. During the sleep time, the terminal may not perform the PDCCH or CORESET monitoring operation 405. That is, in order to receive scheduling information for downlink or uplink radio resources or control information indicating downlink reception, the terminal may perform the PDCCH or CORESET monitoring operation in the on-duration period 402 according to the DRX cycle 404. When the control information causing the terminal to stop the DRX operation is not received in the on-duration period, the terminal may enter the sleep time 430 and may not perform the monitoring operation 405 on the downlink channel during the sleep time 403, thereby reducing power consumption.

Meanwhile, if the reception or transmission operation according to the result of the monitoring operation 405 performed by the terminal in the on-duration period is not terminated within the on-duration period, the terminal may continuously perform the downlink channel monitoring even after the on-duration period ends. Such the monitoring operation period may be defined as an ‘active time 407’. Therefore, the active time may be longer than the on-duration period.

The parameters for the above-described DRX operation may be transmitted to the terminal through a higher layer message (e.g., RRC control message), and the MAC layer of the terminal may mainly perform the DRX operation based on the configured DRX parameters. The DRX parameters (e.g., cycle values) for the DRX operation of the terminal may be configured differently according to the state of the terminal (e.g., state 301, 302 or 303 of FIG. 3). Also, one or more DRX parameters (e.g., cycle values) may be configured for one terminal.

In exemplary embodiments of the present disclosure, in addition to the above-described DRX operation, in order to further reduce power consumption of the terminal, a wake up signal (WUS) or a go-to-sleep signal (GTS) may be considered from the physical (PHY) layer perspective. That is, the WUS and GTS may be PHY layer signals that the base station (or cell) transmits to assist the DRX operation of the terminal. The WUS may be a signal for instructing the terminal to perform a downlink monitoring operation at a physical layer level configured for the terminal. In addition, the GTS may be a signal for instructing the terminal to stop or suspend the downlink monitoring operation at the physical layer level configured for the terminal. Hereinafter, exemplary embodiments to which the WUS is applied and exemplary embodiments to which the GTS is applied will be described respectively. However, exemplary embodiments to which the WUS and the GTS are applied together, exemplary embodiments to which only the WUS signal is applied, and exemplary embodiments to which only the GTS signal is applied are all possible.

Wake-Up Signal (WUS)

FIG. 5 is a conceptual diagram for describing an operation of a terminal based on a WUS according to an exemplary embodiment of the present disclosure.

Referring to FIG. 5, a WUS for waking up the terminal performing a DRX operation according to a DRX cycle 504 may be transmitted in a slot located just before an on-duration period 509 for the terminal or transmitted in the on-duration period 509. FIG. 5 shows a case where the WUS is transmitted in a slot 507 just before the on-duration period 509, but a time point when the WUS is transmitted may not be limited to the example of FIG. 5. As described above, the WUS received before the on-duration period may indicate whether the terminal performs a downlink monitoring operation in the next on-duration period 509. In addition, as shown in FIG. 5, the WUS received in the on-duration period 509 may indicate whether the terminal performs a downlink monitoring operation in the corresponding on-duration period 509.

The WUS may be transmitted in form of a PDCCH 508 or in a separate signal form 505 such as a reference signal. When the WUS is configured in form of a physical layer signal such as a reference signal, as shown in FIG. 5, the WUS may be not transmitted in the entire channel bandwidth, but transmitted in at least one subcarrier and at least one symbol duration. In this case, WUS patterns indicating subcarrier(s) and symbol duration(s) through which the WUS is transmitted may be configured, and a WUS pattern may be assigned to a terminal or terminal group through a control message.

The slot 507 in which the WUS is transmitted in FIG. 5 may mean a downlink slot located immediately before the on-duration period 509. However, the WUS may be configured to be transmitted in a specific slot located before the on-duration period, not the slot 507 immediately before the on-duration period. In this case, an additional offset value may be used to indicate how much earlier the WUS is transmitted (or should be received) from a predetermined reference time point. The offset value (e.g., WUS_OccassionOffset) may be transmitted to the terminal through system information or a control message. Accordingly, the terminal that receives the WUS before the on-duration period according to the offset may wake up to perform the downlink monitoring operation in the next on-duration period. The reference time point may be the starting time point of the on-duration period, the ending time point of the on-duration period, the starting time point of the sleep time, the ending time point of the sleep time, the starting time point of the DRX cycle, or the ending time point of the DRX cycle. In this case, the value of WUS_OccassionOffset may be configured in units of symbols, minislots, slots, subframes, or frames.

When the WUS is transmitted in form of a PDCCH, the WUS may be transmitted using a control field (e.g., DCI field parameter) in the PDCCH. As an example, a specific DCI field may be configured in the PDCCH, and the corresponding field set to ‘1’ may represent a WUS indication (on the other hand, a value of ‘0’ may represent the WUS indication). As described above, when a bit of the DCI control field is set to ‘1’ to indicate the WUS (i.e., performing the downlink monitoring operation), the corresponding field value set to ‘0’ may instruct to stop performing the downlink monitoring operation.

As another example, the WUS may be transmitted using a DCI format additionally defined for WUS transmission, or may be transmitted by using a PDCCH using a scheduling identifier (e.g., C-RNTI, SPS-RNTI, CS-RNTI, TPC RNTI, INT-RNTI, SFI-RNTI) uniquely assigned to the corresponding terminal, a scheduling identifier (e.g., WUS-RNTI) allocated for WUS transmission, or a group scheduling identifier (e.g., Group WUS-RNTI) allocated for WUS transmission. Here, the scheduling identifier for WUS transmission (i.e., WUS-RNTI) may mean a scheduling identifier uniquely assigned to a specific terminal in order to support the WUS function. The group scheduling identifier for WUS transmission (i.e., Group WUS-RNTI) may mean a scheduling identifier commonly applied to one or more terminal groups within the base station. In addition, one of the scheduling identifiers uniquely assigned to the specific terminal (e.g., C-RNTI, SPS-RNTI, CS-RNTI, TPC RNTI, INT-RNTI, SFI-RNTI, etc.) may be configured as the RNTI for WUS transmission and may be used as the WUS-RNTI or the Group WUS-RNTI. That is, a PDCCH itself having a CRC scrambled by the scheduling identifier, which is uniquely assigned to the terminal and configured as the RNTI for WUS transmission, or the scheduling identifier (e.g., WUS-RNTI or Group WUS-RNTI) allocated for WUS transmission may be used as the WUS. Alternatively, a parameter or field information for the WUS function may be included in the PDCCH having the CRC scrambled by the scheduling identifier (e.g., WUS-RNTI or Group WUS-RNTI) allocated for WUS transmission, and the parameter or the field information may be used for the terminal to identify whether to perform the downlink monitoring.

In this case, one or more group scheduling identifiers (i.e., Group WUS-RNTIs) may be allocated for WUS transmission. When a plurality of group scheduling identifiers are allocated as described above, the group scheduling identifier may be included in a control message for connection configuration, and assigned to a specific terminal (or, terminal group). Alternatively, the group scheduling identifiers may be preconfigured so as to have correspondences to properties of terminals, states of terminal, or provided services.

That is, the serving base station (or cell) may transmit the WUS (i.e., information indicating downlink reception) to a terminal or a terminal group in the on-duration period 509 or the downlink slot (e.g., 507) before the on-duration period 509 by using a scheduling identifier for WUS transmission. When the WUS indication is configured and transmitted as the DCI field in the PDCCH, indication information indicating a terminal group targeted by the corresponding WUS may be included in the DCI field. Accordingly, when the WUS on a terminal group basis is used, the terminal group to which the WUS is applied may be identified using the group scheduling identifier or a group identifier in the DCI field.

The operation according to the WUS received from the serving base station (or cell) may be performed independently of the DRX operation controlled by the MAC layer. The reception of the WUS may not affect the DRX operation of the MAC layer. That is, the terminal receiving the WUS may not stop the DRX operation of the MAC layer or may not stop (or reset) the counter or timer for the DRX operation. The terminal receiving the WUS may maintain only a physical layer level monitoring or reception operation for a physical layer downlink control channel or a designated CORESET resource. That is, the terminal receiving the WUS may wake up and perform the downlink monitoring operation in the next on-duration period according to the configured DRX parameter. Here, performing the downlink monitoring operation in the on-duration period may mean starting the timer for the on-duration period 509 and performing a reception operation for a downlink physical layer control channel until the timer expires. Even when entering the sleep time by the configured DRX parameter after the end of the on-duration period described with reference to FIG. 4, the terminal may continuously perform the physical layer level monitoring or reception operation during a WUS monitoring period. Here, the WUS monitoring period may be a WUS configuration parameter, and may indicate a period in the time domain, for which the terminal receiving the WUS should perform the downlink monitoring operation. The WUS monitoring period may start at the time point when the WUS is received or the starting time point of the next on-duration period. The active time 407 itself is not extended due to this, and the MAC layer may continuously perform the DRX operation according to the configured DRX cycle 504. After receiving the WUS, when the operation of the MAC layer is required or the DRX operation needs to be stopped or released as a result of monitoring the physical layer downlink channel, the physical layer of the terminal may immediately inform the related information to the MAC layer of the terminal.

When the terminal is provided with services from a plurality of serving cells or through a plurality of BWPs, the WUS may be transmitted on a cell basis (or BWP basis). That is, the serving cell may instruct the terminal to perform downlink monitoring or downlink reception of a specific cell or a specific BWP by transmitting the WUS together with a cell index (or carrier index) or a BWP index. In addition, the base station may indicate some radio resources (e.g., CORESET resource ID, a separately specified reference signal, etc.) constituting a physical downlink channel, and instruct the terminal to monitor or receive the indicated radio resources.

The information indicating the radio resource to be monitored, such as a cell index, a BWP index, or a CORESET resource ID, may be transmitted as signaling information from the serving cell (or base station) to the terminal through a field in DCI or a MAC control element (CE). The signaling information may be transmitted as including an identifier value representing information indicating the radio resource to be monitored, such as a cell (or BWP) index or a CORESET resource ID, or may be transmitted in form of a bitmap for identifying the radio resource to be monitored, such as a specific cell, a specific BWP, or a specific CORESET resource ID. When the signaling information is transmitted in the form of a bitmap, one bit constituting the bitmap may be configured to have a one-to-one correspondence to information indicating the radio resource to be monitored, such as one cell, one BWP, or one CORESET resource ID.

Meanwhile, when the WUS is configured or indicated, a counter or a timer (e.g., MonitAct_Timer 510 of FIG. 5) indicating a period (or time) for monitoring a physical layer downlink from the time point when the WUS is received may be configured. That is, the timer may indicate a time period for which the received WUS is valid. Therefore, the terminal receiving the WUS may not perform the physical layer downlink monitoring operation according to the WUS reception when MonitAct_Timer 510 indicating the downlink channel monitoring period according to the WUS expires.

When the WUS is transmitted through a MAC CE, the MAC layer of the terminal may make the physical layer wake up and perform the monitoring operation for the downlink channel. Although the physical layer performs the downlink monitoring operation, it may not affect the DRX operation of the MAC layer. For example, the physical layer of the terminal having received the WUS in the form of the PDCCH (e.g., a separate DCI format or a control field in the PDCCH) according to the above description may notify to the MAC layer that the physical layer has received the WUS. That is, the operation of the timer (or counter) for the on-duration period, the DRX cycle, or start/restart/stop/expiry of the related timer according to the DRX operation may be continued, and only the monitoring operation on the physical layer downlink channel of the physical layer according to the WUS reception may be performed.

In addition to the operation according to the WUS reception described above, the following operations may be additionally considered. That is, when the terminal does not receive the WUS in a situation where the WUS is configured (that is, the time point when the WUS is transmitted is configured) or when the terminal misses the WUS transmitted by the base station at the corresponding time point, the terminal may not perform the monitoring operation on the downlink channel even in the on-duration period according to the configured DRX parameter. That is, when the WUS is not received, the terminal may not perform the monitoring operation on the downlink channel even in the on-duration period according to the DRX cycle controlled by the MAC layer. Here, not performing the downlink monitoring operation in the on-duration period may mean that the timer for the on-duration period 502 is not started. However, it may not affect the operation of the counter and timer for the DRX operation managed by the MAC layer. That is, the starts and ends of the on-duration period and the sleep time according to the configured DRX parameters may not be affected. However, drx-InactivityTimer, which starts when a PDCCH (not retransmitted PDCCH) is successfully received in the DRX operation, may be configured to start or restart even when receiving the WUS.

Considering the case where the terminal misses the WUS, the base station may instruct the terminal receiving the WUS to transmit a response message or signal for the received WUS. Alternatively, the terminal receiving the WUS may be configured to transmit a response message or signal for the received WUS. The terminal receiving the WUS may transmit control information (or a signal) indicating that the WUS has been successfully received, by using a resource allocated by the base station or a configured resource. The base station that does not receive the response control information indicating successful reception of the WUS from the terminal may retransmit the WUS or may instruct the terminal to wake up and start monitoring of the downlink channel or uplink transmission by using a downlink signal or scheduling information (e.g., transmission of DCI/UCI or transmission of scheduling information using C-RNTI) in the on-duration period according to the DRX cycle.

Go-to-Sleep Signal (GTS)

The GTS may be a signal for stopping or suspending monitoring at the physical layer independently of the DRX operation performed at the MAC layer. When the GTS is configured, regardless of whether the terminal performs the DRX operation, the serving base station (or cell) may instruct the terminal to stop the physical layer downlink monitoring operation of the terminal by transmitting the GTS to the terminal.

Accordingly, the serving base station (or cell) may transmit the GTS to instruct the corresponding terminal to stop the physical layer downlink monitoring operation even before the execution of the DRX operation starts according to the configured DRX parameters.

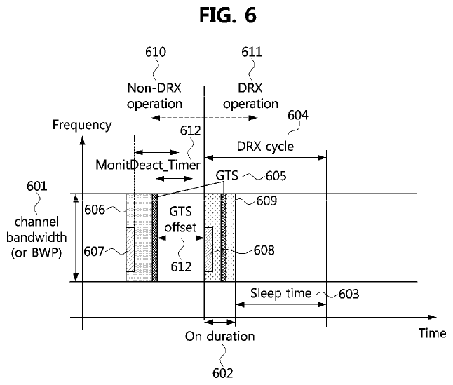

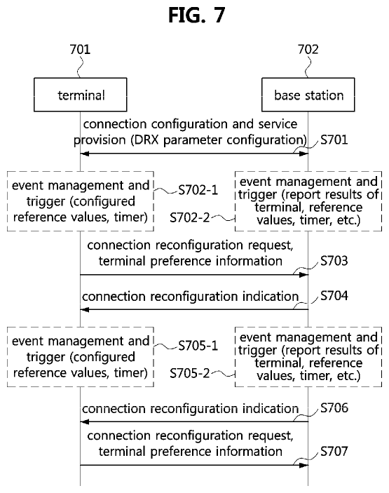

FIG. 6 is a conceptual diagram for describing an operation of a terminal based on a GTS according to an exemplary embodiment of the present disclosure.

Referring to FIG. 6, the GTS may be transmitted in a period 610 before the terminal starts the DRX operation. Alternatively, when the terminal is in the DRX operation 611 according to a DRX cycle 604, the GTS may be transmitted in an on-duration period 602 of the terminal.

When the GTS is transmitted in the period 610 before the terminal starts the DRX operation, the base station (or cell) may transmit the GTS at a necessary time point or in a period 606 (or at a time point) promised according to a preconfigured parameter. That is, when the GTS is transmitted before the on-duration period 602, a separate offset value 612 may be used to indicate how much earlier the GTS is transmitted (or should be received) from a predetermined reference time point, not in the slot just before the on-duration period 602. The GTS received before the on-duration period as described above may indicate whether to stop the downlink monitoring operation of the terminal in the next on-duration period 602. In addition, as shown in FIG. 6, the GTS received in the on-duration period 602 may indicate whether to stop performing the downlink monitoring operation in the corresponding on-duration period 602. The offset (e.g., GTS_OccassionOffset) may be transmitted to the terminal through system information or a control message. The reference time point may be the starting time point of the on-duration period, the ending time point of the on-duration period, the starting time point of the sleep time, the ending time point of the sleep time, the starting time point of the DRX cycle, or the ending time point of the DRX cycle. In this case, the value of GTS_OccassionOffset may be configured in units of symbols, minislots, slots, subframes, or frames. Accordingly, the reference time point of the offset GTS_OccassionOffset 612 may be expressed as the starting time point or the ending time point of the DRX cycle, the starting time point of the on-duration period, the ending time point of the on-duration period (or active time), the starting time point of the sleep time, the ending time point of the sleep time, or the like.

The GTS may be transmitted in form of a PDCCH 607 or 608 or in form of a separate signal 605 such as a reference signal. When the GTS is configured in form of a physical layer signal such as a reference signal, as exemplified by 605 of FIG. 5, the GTS may be not transmitted in the entire channel bandwidth, but transmitted in at least one subcarrier and at least one symbol duration. In this case, GTS patterns indicating subcarrier(s) and symbol duration(s) through which the GTS is transmitted may be configured, and a GTS pattern may be assigned to a terminal or terminal group through a control message.

When the GTS is transmitted in form of a PDCCH, the GTS may be transmitted using a control field (e.g., DCI field parameter) in the PDCCH. As an example, a specific DCI field may be configured in the PDCCH, and the corresponding field set to ‘1’ may represent a GTS indication (on the other hand, a value of ‘0’ may represent the GTS indication). As described above, when a bit of the DCI control field is set to ‘1’ to indicate the GTS (i.e., stopping the downlink monitoring operation), the corresponding field value set to ‘0’ may instruct to perform the downlink monitoring operation.

As another example, the GTS may be transmitted using a DCI format additionally defined for GTS transmission, or may be transmitted by using a PDCCH using a scheduling identifier (e.g., C-RNTI, SPS-RNTI, CS-RNTI, TPC RNTI, INT-RNTI, SFI-RNTI) uniquely assigned to the corresponding terminal, a scheduling identifier (e.g., GTS-RNTI) allocated for GTS transmission, or a group scheduling identifier (e.g., Group GTS-RNTI) allocated for GTS transmission. That is, a PDCCH itself having a CRC scrambled by the scheduling identifier uniquely assigned to the terminal, or the scheduling identifier (e.g., GTS-RNTI) or the group scheduling identifier (e.g., Group GTS-RNTI) allocated for GTS transmission may be used as the GTS. Here, the scheduling identifier for GTS transmission (e.g., GTS-RNTI) may mean a scheduling identifier uniquely assigned to a specific terminal for supporting the GTS function. The group scheduling identifier for GTS transmission (e.g., Group GTS-RNTI) may mean a scheduling identifier commonly applied to one or more terminal groups within the base station. In addition, one of the scheduling identifiers uniquely assigned to the specific terminal (e.g., C-RNTI, SPS-RNTI, CS-RNTI, TPC RNTI, INT-RNTI, SFI-RNTI, etc.) may be configured as the RNTI for GTS transmission and may be used as the GTS-RNTI or the Group GTS-RNTI.

A parameter or field information for the GTS function may be included in the PDCCH having the CRC scrambled by the scheduling identifier which is uniquely assigned to the terminal and configured for GTS transmission or the scheduling identifier (e.g., GTS-RNTI or Group GTS-RNTI) allocated for GTS transmission, and the parameter or the field information may be used for the terminal to identify whether to stop performing the downlink monitoring.

In this case, one or more group scheduling identifiers (i.e., Group GTS-RNTIs) may be allocated. When a plurality of group scheduling identifiers are allocated as described above, the group scheduling identifier may be included in a control message for connection configuration, and assigned to at least one terminal (or, terminal group). Alternatively, the group scheduling identifiers may be preconfigured so as to have correspondences to properties of terminal, states of terminal, or provided services.

That is, the serving base station (or cell) may transmit the GTS (i.e., information instructing to stop downlink reception or monitoring) to a terminal or a terminal group in the on-duration period 602 or the downlink slot 607 before the on-duration period 602 by using the scheduling identifier for GTS transmission. When the GTS indication is configured and transmitted as the DCI field in the PDCCH, indication information indicating a terminal group targeted by the corresponding GTS may be included in the DCI field. Accordingly, when the GTS is used on a terminal group basis, the terminal group to which the GTS is applied may be identified using the group scheduling identifier or a group identifier in the DCI field.

When the terminal is provided with services from a plurality of serving cells or through a plurality of BWPs, the GTS may be signaled on a cell basis (or BWP basis). That is, the serving cell may instruct the terminal to stop downlink monitoring on or downlink reception of a downlink channel or a designated radio resource (e.g., CORESET resource or PDCCH) of the downlink channel of a specific cell or a specific BWP by transmitting the GTS together with information for identifying the radio resource on which the monitoring is to be stopped, such as a cell index (or carrier index), a BWP index, or a CORESET resource ID. The information indicating the radio resource on which the monitoring is to be stopped, such as a cell index, a BWP index, or a CORESET resource ID, may be transmitted as signaling information from the serving cell (or base station) to the terminal through a field in DCI or a MAC CE. The signaling information may be transmitted as including an identifier value representing information indicating the radio resource on which the monitoring is be stopped, such as a cell (or BWP) index or a CORESET resource ID, or may be transmitted in form of a bitmap for identifying the radio resource on which the monitoring is to be stopped in a specific cell, a specific BWP, or a specific CORESET resource ID. When the signaling information is transmitted in form of a bitmap, one bit constituting the bitmap may be configured to have a one-to-one correspondence to information indicating the radio resource on which the monitoring is to be stopped in one cell, one BWP, or one CORESET resource ID.

When the GTS is transmitted through a MAC CE, the MAC layer of the terminal may inform the physical layer of the reception of the GTS and instruct to stop the physical layer downlink monitoring operation. The terminal receiving the GTS may not perform the downlink monitoring operation from the time point of receiving the GTS or in the next on-duration period according to the DRX parameter. In addition, when the GTS is configured or indicated, a counter or a timer (e.g., MonitDeact_Timer 612 of FIG. 6) indicating a period (or time) in which the physical layer of the terminal stops (or suspends) downlink monitoring or downlink reception. That is, the timer may indicate a time period for which the received GTS is valid. Accordingly, the terminal receiving the GTS may suspend (or stop) the downlink monitoring operation according to the GTS until the counter or timer (e.g., MonitDeact_Timer 612) indicating the period in which the downlink monitoring is suspended (or stopped) expires.

The operation of the terminal according to the reception of the GTS may be suspending or stopping the physical layer downlink monitoring operation from the time point of receiving the GTS or in the next on-duration period according to the DRX parameter until the above-described timer (e.g., MonitDeact_Timer 612) expires. That is, when the MonitDeact_Timer 612 expires after the reception of the GTS, the terminal may release the suspension of the physical layer downlink monitoring and start the monitoring operation in consideration of the configured parameters for the DRX operation. In addition, when the terminal transmits a scheduling request (SR) or a random access (RA) channel preamble, or when an SR or RA procedure is triggered, the terminal may release the suspension of the physical layer downlink monitoring due to the reception of the GTS. Accordingly, when the SR or PRACH transmission is triggered by the MAC layer or an RA preamble (PRACH) index is transferred from the MAC layer, the physical layer of the terminal may transmit the triggered SR or PRACH and start the physical layer downlink monitoring operation. In addition, when the MonitDeact_Timer 612 is running, the corresponding timer may be stopped or reset.

Meanwhile, in the above-described operation according to the reception of the GTS, a separate timer (e.g., GTS_Timer) may be configured to indicate the time point when the operation according to the GTS reception is performed. For example, when the GTS is received, the timer may start, and the terminal may be configured to perform the above-described operation according to the reception of the GTS when the timer expires.

The operation according to the reception of the GTS may performed independently of the DRX operation performed by the MAC layer of the terminal. Therefore, it may not affect the starts and ends of the on-duration period, the sleep time, and the active time according to the DRX parameters configured in the MAC layer.

In addition, when the GTS is not received in a situation where the GTS is configured (i.e., the time point when the GTS is transmitted is configured), the terminal may perform the DRX operation according to the configured DRX parameters. The terminal may not perform the downlink monitoring operation during the sleep time after performing the downlink monitoring operation in the on-duration period. Therefore, the operation of the counters and timers for the DRX operation managed by the MAC layer may not be affected. That is, the starts and ends of the on-duration period, the sleep time, and the active time according to the configured DRX parameters may not be affected. However, drx-InactivityTimer, which starts when a PDCCH (not retransmitted PDCCH) is successfully received in the DRX operation, may be configured to start or restart according to the reception of the GTS.

A value for configuring the above-described timer (or counter) (e.g., MonitAct_Timer 510) for configuring the period for which the downlink is monitored after receiving the WUS or a value for configuring the timer (or counter) (e.g., MonitDeact_Timer 612) for configuring the period in which the downlink monitoring is suspended after receiving the GTS or a value for configuring GTS_Timer may be transferred to the terminal through system information, an RRC layer control message, a MAC CE message, or DCI transmitted on a PDCCH. In addition, one or more values for the corresponding timer (MonitAct_Timer or MonitDeact_Timer) may be configured. For example, a plurality of timer values may be configured as shown in Table 1 and Table 2 below.

TABLE 1

| WUS timer index | MonitAct_Timer |
|---|---|
| 00 | 4 |
| 01 | 8 |
| 10 | 16 |
| 11 | 32 |

TABLE 2

| GTS timer index | MonitDeact_Timer |
|---|---|
| 00 | 8 |
| 01 | 16 |
| 10 | 32 |
| 11 | 64 |

The timer values (e.g., MonitAct_Timer, MonitDeact_Timer, or GTS_Timer) may be configured in units of symbols, minislots, slots, subframes, or frames.

In addition, when the terminal is in the DRX operation according to the configured DRX cycle, the MonitDeact_Timer value may mean the number of on-duration periods according to the DRX cycle after receiving the GTS. That is, when the MonitDeact_Timer value is set to ‘4’ and the terminal performing the DRX operation receives the GTS, the monitoring operation or reception operation for the physical layer may be stopped in the on-duration periods for four consecutive DRX cycles after receiving the GTS.

The above-described timer indexes and timer values may be transmitted to the terminal in advance using system information or an RRC layer control message. The serving cell (or base station) may transmit a WUS timer index together with the WUS or transmit a GTS timer index with the GTS by using a MAC CE or DCI transmitted through a PDCCH. The terminal receiving the corresponding timer index together with the WUS (or GTS) may perform the operation according to the reception of the WUS or the GTS until expiration of the timer (MonitAct_Timer or MonitDeact_Timer) set according to the timer value indicated by the corresponding timer index.

Meanwhile, the WUS or GTS described above may be transmitted on a terminal group basis. As described above, the WUS or GTS composed of at least one subcarrier and at least one symbol duration in form of a reference signal may be assigned to a least one terminal group, and the WUS or GTS may be transmitted to the at least one terminal group. When the group-based WUS or GTS is received, a terminal belonging to the corresponding terminal group may perform the above-described operation according to the reception of the WUS or GTS.

When the WUS or GTS is transmitted in form of a PDCCH or a MAC CE, a group identifier indicating a target group of the WUS or GTS may be transmitted as included in DCI of the PDCCH or the MAC CE. Alternatively, the PDCCH may be transmitted using a scheduling identifier configured or allocated for supporting the WUS or GTS function. In this case, the scheduling identifier may be one of C-RNTIs configured or allocated to indicate at least one terminal or at least one terminal group targeted by the WUS or GTS.

Downlink Channel Monitoring Signal

In the above-described exemplary embodiments, cases where the WUS and the GTS are configured as separate signals have been described. Alternatively, a signal into which the WUS and GTS described above are integrated may be used.

For example, a physical layer downlink channel monitoring signal (hereinafter also referred to as ‘PDCCH_MonitSig’) may be defined so that the PDCCH_MonitSig may indicate ‘Wake Up (WUS)’ or ‘Go to sleep (GTS)’. When the PDCCH_MonitSig is transmitted in the above-described reference signal from, patterns for the PDCCH_MonitSig, each of which is composed of at least one subcarrier and at least one symbol duration, may be divided into patterns for WUS and patterns for GTS. Also, a different masking (or scrambling) sequence according to whether the same pattern is for WUS or GTS may be applied to and transmitted in the subcarrier(s) and symbol(s) constituting the same pattern.

Alternatively, when the PDCCH_MonitSig is configured in form of a MAC CE or DCI in a PDCCH, a specific bit of PDCCH_MonitSig, which is set to ‘1’, may indicate that the PDCCH_MonitSig is the WUS (e.g., performing downlink monitoring), and the specific bit set to ‘0’ may indicate that the PDCCH_MonitSig is the GTS (e.g., not performing downlink monitoring). In this case, the PDCCH may be transmitted using a scheduling identifier configured or allocated for PDCCH_MonitSig transmission as in the above-described WUS or GTS operation. The scheduling identifier for PDCCH_MonitSig transmission (e.g., PS-RNTI) may mean a scheduling identifier uniquely assigned to a specific terminal for PDCCH_MonitSig transmission. A group scheduling identifier (e.g., Group PS-RNTI) for PDCCH_MonitSig transmission may be a scheduling identifier commonly applied to one or more terminal groups within the base station. In addition, one of the scheduling identifiers uniquely assigned to the specific terminal (e.g., C-RNTI, SPS-RNTI, CS-RNTI, TPC RNTI, INT-RNTI, SFI-RNTI, etc.) may be configured as the RNTI for PDCCH_MonitSig transmission and may be used as the PS-RNTI or the Group PS-RNTI. Accordingly, a PDCCH itself (e.g., DCI control field) having a CRC scrambled by the scheduling identifier, which is uniquely assigned to the terminal and configured as the RNTI for PDCCH_MonitSig transmission, or the scheduling identifier (e.g., PS-RNTI or Group PS-RNTI) allocated for PDCCH_MonitSig transmission may be used as the PDCCH_MonitSig. When a value of the corresponding bit is ‘1’, the terminal receiving the PDCCH_MonitSig may wake up and perform the physical layer downlink monitoring operation according to the WUS operation procedure described above. That is, the terminal receiving the PDCCH_MonitSig having the corresponding bit set to ‘1’ may wake up for the downlink monitoring. The terminal may start a timer for the next on-duration period according to the configured DRX parameter and perform the downlink monitoring operation until the timer expires.

On the other hand, the terminal receiving the PDCCH_MonitSig may stop (or suspend) the physical layer downlink monitoring operation according to the GTS operation procedure described above when the value of the corresponding bit is ‘0’. That is, the terminal receiving the PDCCH_MonitSig having the corresponding bit set to ‘0’ may not start the timer for the next on-duration period according to the configured DRX parameter, and thus may not perform the downlink monitoring operation in the corresponding on-duration period. Alternatively, the downlink monitoring operation may not be performed from the time point of receiving the PDCCH_MonitSig until a new on-duration period after the on-duration period to which the PDCCH_MonitSig is applied starts. Here, it is also possible to set the bit (or information) value of the PDCCH_MonitSig in reverse (e.g., ‘0’ indicates the WUS, and ‘1’ indicates the GTS). In addition, the group identifier indicating the target group of the PDCCH_MonitSig transmission may be transmitted as included in the MAC CE or the DCI in the PDCCH. Alternatively, the PDCCH may be transmitted using the scheduling identifier configured or allocated for supporting the PDCCH_MonitSig function. In this case, the scheduling identifier may be one of scheduling identifiers configured or allocated to indicate at least one terminal or at least one terminal group targeted by the PDCCH_MonitSig.

As another method, the WUS, GTS, or PDCCH_MonitSig may be identified using a logical channel identifier (LCID). That is, a method of distinguishing the WUS, GTS, or PDCCH_MonitSig by using a LCID included in a MAC header (or subheader) or a MAC message may be used. Alternatively, a different LCID may be allocated according to whether the information indicated by the PDCCH_MonitSig is ‘WUS’ or ‘GTS’.

The above-described PDCCH_MonitSig may also be signaled together with timer information indicating a valid period (e.g., PDCCH_MonitTimer) starting from the time point of receiving the corresponding PDCCH_MonitSig. Alternatively, a separate timer (e.g., MonitOffset_Timer) may be configured, and when the PDCCH_MonitSig is received, the corresponding timer (e.g., MonitOffset_Timer) may be started, and the above-described operation according to the reception of the PDCCH_MonitSig may be configured to be performed when the timer (e.g., MonitOffset_Timer) expires. A value for configuring MonitOffset_Timer or PDCCH_MonitTimer for the PDCCH_MonitSig may be transferred to the terminal through system information, an RRC layer control message, a MAC CE message, or DCI transmitted through a PDCCH. Also, as shown in Table 3 below, one or more PDCCH_MonitTimer values may be configured.

TABLE 3

| PDCCH_MonitSig timer index | PDCCH_MonitTimer |
|---|---|
| 00 | 4 |
| 01 | 8 |
| 10 | 16 |
| 11 | 32 |

The timer values (e.g., MonitOffset_Timer or PDCCH_MonitTimer) may be configured in units of symbols, minislots, slots, subframes, or frames. In addition, when the terminal is in the DRX operation according to the configured DRX cycle, the PDCCH_MonitTimer value may mean the number of on-duration periods according to the DRX cycle after receiving the PDCCH_MonitSig. That is, when the PDCCH_MonitTimer value is set to ‘4’ and the terminal performing the DRX operation receives the PDCCH_MonitSig, the monitoring operation or reception operation for the physical layer may be performed or stopped in the on-duration periods for four consecutive DRX cycles after receiving the PDCCH_MonitSig.

The above-described PDCCH_MonitSig timer indexes and PDCCH_MonitTimer timer values may be transmitted to the terminal in advance using system information or an RRC layer control message. The serving cell (or base station) may transmit the PDCCH_MonitSig timer index together with the PDCCH_MonitSig by using a MAC CE or DCI transmitted through a PDCCH. The terminal receiving the corresponding timer index together with the PDCCH_MonitSig may perform the operation according to the reception of the PDCCH_MonitSig until expiration of the timer PDCCH_MonitTimer set according to the timer value indicated by the corresponding timer index.

The time position at which the terminal receives the PDCCH_MonitSig may be configured using a separate offset value (e.g., Corse tMonit_OccassionOffset) with respect to a reference time point. The reference time point may be the starting time point of the on-duration period, the ending time point of the on-duration period, the starting time point of the sleep time, the ending time point of the sleep time, the starting time point of the DRX cycle, or the ending time point of the DRX cycle. For example, the terminal may receive the PDCCH_MonitSig at a time point earlier by the offset value CorsetMonit_OccassionOffset than the reference time point. The CorsetMonit_OccassionOffset information may be transmitted to the terminal through system information or a control message. The CorsetMonit_OccassionOffset may be configured in units of symbols, minislots, slots, subframes, or frames.

As described in the operation according to the reception of the WUS or GTS, the operations according to the reception of the PDCCH_MonitSig or the start or end of the PDCCH_MonitTimer may be performed independently of the DRX operation of the MAC layer performed based on the DRX cycle, the on-duration period, the active time, or the sleep time according to the configured DRX parameters.

However, in case that PDCCH_MonitSig is received according to the configuration, drx-InactivityTimer, which starts when a PDCCH (not retransmitted PDCCH) is successfully received in the DRX operation driven by the MAC layer, may start or restart when the PDCCH_MonitSig is received.

In addition, when the drx-InactivityTimer expires or a separately configured timer (e.g., ToLongDRX_timer) expires after receiving the GTS or after the GTS_Timer expires, the DRX operation may be triggered to be performed according to the configured DRX parameters. Alternatively, the DRX operation may be triggered using the longest DRX cycle among the DRX parameters configured in the corresponding terminal.

In addition, after receiving the PDCCH_MonitSig signal indicating the GTS, or when the PDCCH_MonitTimer expires or when the separately configured timer (e.g., ToLongDRX_timer) expires, the DRX operation may be triggered to be performed according to the configured DRX parameters. Alternatively, the DRX operation may be triggered using the longest DRX cycle among the DRX parameters configured in the corresponding terminal. In this case, ToLongDRX_timer may be configured to be equal to or smaller than InactivityTimer.

Conditions for triggering the base station (or, cell) to transmit the PDCCH_MonitSig signal, which means the GTS or GTS described above, may be configured as follows.
When buffer status information reported by the terminal indicates ‘zero (or empty)’, or
When the separate timer, which is configured for GTS transmission or for transmission of PDCCH_MonitSig indicating GTS, expires

The base station (or cell) may transmit control information indicating whether the WUS, GTS, or PDCCH_MonitSig described above is supported to the terminal using system information or a dedicated control message. In addition, the terminal may transmit capability information indicating whether the WUS, GTS, or PDCCH_MonitSig is supported, when the terminal registers with the system, or when the terminal configures a connection with the base station. Accordingly, the serving base station (or cell) may determine whether to configure the WUS, GTS, or PDCCH_MonitSig on a terminal or terminal group basis, and transmit the following configuration information of the WUS, GTS, or PDCCH_MonitSig using an RRC layer control message.
Index of a group targeted by configuration of the WUS, GTS, or PDCCH_MonitSig
WUS, GTS, or PDCCH_MonitSig timer indexes
MonitAct_Timer, MonitDeact_Timer, or PDCCH_MonitTimer values
Offset parameter indicating the time point of receiving the WUS, GTS, or PDCCH_MonitSig

Connection reconfiguration for low power consumption operation of terminal

The terminal may transmit at least part of the following preference information (i.e., UE preference information) to the serving base station (or cell) in consideration of the low power consumption operation of the terminal.
Preference for a DRX cycle longer than a configured DRX cycle
Preference for a DRX cycle shorter than a configured DRX cycle
Preference for activation or deactivation of a measurement relaxation operation
Information for releasing (or requesting) a low-latency service
Information for releasing (or requesting) a time tolerance service
Preference for deactivation (or release of configuration) of the DRX operation
Information indicating presence of (or, connection to) an additional power supply device
Information indicating a charge state of a battery (e.g., state of charge (SOC), remaining battery time, etc.)
Information for requesting to switch the active BWP
Preference for activation of the WUS, GTS, or PDCCH_MonitSig
Preference for deactivation of the WUS, GTS, or PDCCH_MonitSig
Information for requesting to change the state of the terminal
Information for requesting to change the configuration of the CORESET

The additional power supply-related information may mean information indicating whether the terminal is supplied with power through an additional external power supply. Through this, the terminal may inform to the base station whether the DRX operation and/or the power saving operation of the terminal is needed. Here, whether the operation is necessary may mean configuring the DRX operation and/or the power saving operation of the terminal or releasing the configuration thereof. Alternatively, whether the operation is necessary may mean activation or deactivation of the configured operation. For example, when the connection with the external power supply device is released, information informing that the DRX operation and/or the power saving operation of the terminal needs to be configured and/or activated may be transmitted.

The preference information for activation or deactivation of the measurement relaxation operation may mean information for signaling whether the measurement relaxation operation performed by the terminal is preferred. Here, the measurement relaxation operation may mean an operation for reducing loads caused due to the measurement or measurement reporting performed by the terminal by increasing a reporting period of measurement or decreasing the number of measurement objects (or, measurement reports) in the intra-frequency or inter-frequency measurement operation that the terminals performs for the serving cell or neighbor cells. Accordingly, in a situation where power consumption needs to be reduced, the terminal may signal information requesting activation of the measurement relaxation operation to the base station. When a condition for releasing (or deactivating) the power saving operation or the measurement relaxation operation is satisfied, when a reference condition for maintaining (or managing) the quality of services being provided is satisfied, when the movement speed (or mobility status) of the terminal satisfies a preconfigured reference condition, or when the performance of the mobility function is required to be enhanced, the terminal may signal information requesting deactivation of the measurement relaxation operation to the base station.

The information requesting to change the state of the terminal may mean information requesting to change the connection state of the terminal or informing a preferred connection state. The information requesting to change the state of the terminal may be transmitted as included in a response message to state change indication of the base station or a message for the terminal to request the state change. Also, the information on the state change of the terminal may be transmitted to the terminal using a state change indication message of the base station. Through the information requesting to change the state of the terminal, the terminal may request transition from the connected state (e.g., RRC connected state) to the inactive state (e.g., RRC inactive state) or the idle state (e.g., RRC idle state), or signal that the terminal desires the transition to the corresponding state (i.e., the inactive state or the idle state). In addition, the terminal may request transition from the inactive state (e.g., RRC inactive state) to the idle state (e.g., RRC idle state), or may signal that the terminal desires the transition to the corresponding state (i.e., the idle state).

The message instructing the state transition of the terminal transmitted by the base station, the response message of the terminal to the state transition instruction of the base station, or the message transmitted by the terminal for requesting to change the state or for transmission of UE assist information for the state change may be configured to include at least part of the following information or may be transmitted together with at least part of the following information.
Information on the terminal state after the state transition
Timing information for the state transition operation
Information on a desired time (or time period) for which the terminal remains in the corresponding state after the state transition
Information on a minimum time (or time period) for which the terminal remains in the corresponding state after the state transition
Operating frequency after the state transition
Radio access technology (RAT) (e.g., 3GPP LTE/LTE-A system, 3GPP NR system, WiFi, etc.) which the terminal accesses or camp on after the state transition
The shape and type of the serving cell or camped cell after the state transition
Mobility status information before/after the state transition
Mobility history information at a preconfigured time (or in a preconfigured time period) before the state transition
Buffer status information of the terminal
Location information of the terminal (e.g., geographical location information based on a positioning result using a GPS, a built-in sensor, a positioning RS, etc.)
QoS information of the currently-serviced bearer
Information on the type, traffic pattern, QoS, etc. of a desired (or interested) service
Information on a DRX operation level after the state transition (e.g., DRX configuration parameters (DRX cycle and related timer configuration values))
Information on a measurement operation level after the state transition (e.g., configuration parameters for the measurement on and/or the measurement reporting of the serving cell and neighbor cells)

The mobility status information before/after the state transition may be information indicating the mobility status of the terminal before and/or after the state transition, and may mean information representing the movement speed of the terminal (or, scaling factor by which the movement speed can be estimated), the movement method of the terminal (or user), whether the movement method is changed, or the like. Here, the movement method may mean whether or not to board a transportation means (e.g., bicycle, motorcycle, vehicle, subway, train, ship, airplane, etc.), a state as a pedestrian, and the like.

The mobility history information at a preconfigured time (or in a preconfigured time period) before the state transition may mean information on the movement speed (e.g., average speed, maximum speed, minimum speed, etc.) at the corresponding time (or in corresponding the time period), the number of revisiting (or re-entry) the same cell, the number of cell changes, handover execution history information, an average residence time per cell, or the like. Here, the handover execution history information may refer to information on the number of handover executions, the number of handover failures, the handover success rate, the handover failure rate, or the like, and the handover execution history information may be configured for each handover type.

The information requesting to switch the active BWP may be information for requesting to change the active BWP of the terminal to a BWP narrower than the current active BWP. For example, it may be information requesting to switch the BWP used for the terminal to monitor or transmit in the frequency axis to an initial BWP, a default BWP, or the like. In this case, the initial BWP or the default BWP may mean a BWP having a narrower bandwidth than the current active BWP configured for the terminal. In this case, the terminal may transmit an identifier of the corresponding BWP to the base station.

The information requesting to change the CORESET configuration may be information for requesting to change configuration of CORESET resources of the physical layer in which the terminal monitors or receives a downlink PDCCH for DCI transmitted by the base station or UCI. The terminal may request to decrease (or increase) the configured CORESET resources or to decrease (or increase) of the number of CORESET resources on which the monitoring operation is actually performed. When requesting to increase or decrease the number of CORESET resources on which the monitoring operation is actually performed without changing the configuration information of the CORESET resources, index information of the CORESET resources on which the monitoring operation is actually performed needs to be transmitted or index information of the corresponding CORESET needs to be preconfigured. When the index information of the corresponding CORESET is preconfigured, the base station may control the CORESET monitoring operation of the corresponding terminal by transmitting control information instructing the terminal to decrease (or increase) the number of the CORESET resources on which the monitoring operation is actually performed. When the index information of the corresponding CORESET is not preconfigured, the terminal may request to decrease (or increase) the number of CORESET resources on which the monitoring operation is actually performed, and the base station may transmit the index information of the CORESET resources on which the monitoring operation is to be actually performed.

Each of the preference information of the terminal that the terminal transmits (or signals) to the base station for the low power consumption operation may be configured as one bit information. Alternatively, the preference information may be configured in form of a bitmap represented by a plurality of bit strings. Alternatively, the preference information of the terminal may be configured in form of a MAC control message (e.g., MAC CE or a control PDU) of the MAC layer, or a control message of the RRC layer. When the preference information of the terminal is configured as one bit, the terminal supporting the corresponding function (or preference information) may set the value of the corresponding bit to ‘1’ or ‘0’ to signal whether the corresponding preference information is requested (or whether the function for the corresponding preference information is supported or not). When the preference information of the terminal is configured as a bitmap, a method of signaling the preference information by mapping a specific bit of the bitmap to the preference information on a one-to-one basis and setting the value of the corresponding bit to ‘1’ or ‘0’ may be used. Alternatively, a method of signaling information into which one or more preference information are integrated among the preference information together with information on whether a function for specific preference information is supported through the entire value of the bitmap may be used.

FIG. 7 is a sequence chart illustrating a procedure for reconfiguring a connection with a base station for a low power consumption operation of a terminal according to an exemplary embodiment of the present disclosure.

Referring to FIG. 7, a procedure of controlling connection configuration for the low power consumption operation for the terminal 701 in the connected state 301 or the inactive state 302 of FIG. 3, which is performed after a connection with the base station 702 is configured, is shown.

After configuring the connection with the base station 702, the terminal 701 may receive a service or perform a DRX operation according to connection configuration information (e.g., RRC configuration parameters or RRC context information) of the base station (S701).

The terminal 701 may manage events for the DRX operation, measurement/measurement reporting operation, etc. based on configured reference value(s) and/or timer value(s) according to the connection configuration information received from the base station, and when the reference value(s) and/or timer value(s) for a preconfigured condition are satisfied, the terminal 701 may trigger the corresponding event (S702-1).

For example, in the operation of the step S702-1, when at least one condition (or selectively combined conditions) among the conditions listed below is satisfied, the terminal may request transition of the DRX operation (e.g., transition between the non-DRX operation and the DRX operation) or change of the DRX configuration parameters to the base station, or transmit to the base station a connection reconfiguration request message for requesting to stop (or deactivate) the measurement/measurement reporting operation or change the configuration parameters for the measurement/measurement reporting operation (S703). In addition, the terminal may generate the above-described preference information (e.g., UE preference information or UE assist information), and may transmit the preference information to the base station 702 by including it in the connection reconfiguration request message or together with the connection reconfiguration request message.
When there is no data exchange between the base station and the terminal for a preconfigured time and the transmission buffer is empty or below a reference value
When a measurement/measurement reporting related event does not occur for a preconfigured time
When the measurement value or measurement reporting value, or the variation (or deviation) of the corresponding value for a preconfigured time satisfies a preconfigured condition
When a result of estimating the movement status from the terminal satisfies a condition for changing mobility management of the terminal
When the user requests a change through the manual configuration of the terminal
When the measurement value or measurement reporting value satisfies a predefined condition (e.g., a threshold value)

According to the result of the step S702-1, the terminal 701 may transmit the above-described control message requesting connection reconfiguration or the preference information of the terminal to the base station 722 (S705).

In addition, when the corresponding preconfigured condition (e.g., reference value and/or timer) is satisfied based on the state of the terminal, the reporting message from the terminal, or the reference value and/or timer configured by the system, the base station 702 may trigger the corresponding event (S702-2).

For example, in the step S702-2, when at least one condition (or, selectively combined conditions) of the following conditions is satisfied, the base station may instruct the terminal to transition (or reconfigure) the DRX operation (i.e., transition between the non-DRX operation and the DRX operation) or change the DRX configuration parameter, or reconfigure or instruct the terminal to stop (or deactivate) the measurement/measurement reporting operation or change the measurement/measurement reporting parameters. In this case, when the base station receives the above-described preference information (e.g., UE preference information or UE assist information), the base station may generate and transmit a corresponding control message based on the preference information, or generate and transmit a corresponding control message without reflecting the preference information according to the control function or configuration condition of the base station.
When there is no data exchange between the base station and the terminal for a preconfigured time and the transmission buffer is empty or below a reference value
When the transmission buffer of the terminal is empty or below a reference value as a result of a buffer status report (BSR) from the terminal
When a measurement-related event does not occur for a preconfigured time
When the variation (or deviation) of the measurement result or measurement reporting value satisfies a preconfigured condition for a preconfigured time
When it is determined that the mobility management of the terminal is not necessary according to the result of estimating the mobility of the terminal
When the user requests a change through the manual configuration of the terminal
When the measurement value or measurement reporting value satisfies a predefined condition (e.g., a threshold value)

In addition to the above-described conditions, the base station and/or the terminal may configure to extend the DRX operation cycles (e.g., DRC cycle or DRX operation related timers such as the on-duration timer, inactivity timer, and retransmission timer) and the measurement/measurement reporting periodicity according a preconfigured method (or condition). For example, when one or more DRX parameter sets are configured through the connection configuration information, and a reference condition is satisfied, the DRX operation may be performed (or instructed) by changing the current DRX parameter set to a different DRX configuration parameter set, or the change of the corresponding configuration may be triggered.

That is, when the above-described condition is satisfied or a separately configured condition is satisfied, the base station and/or the terminal may configure the DRX operation cycle (e.g., short DRX cycle or long DRX cycle), the measurement/measurement reporting periodicity, and the timer values (e.g., on-duration timer, inactivity timer, retransmission timer, etc.) to be longer than the previous values, decrease the measurement objects, or change parameters (e.g., SS/PBCH block periodicity, offset, duration, etc. for the measurement) of the measurement time (e.g., SS/PBCH block measurement time configuration (SMTC)) to be larger or smaller than the current configured values. To this end, the base station may transmit a separate control message to the terminal so as to control the terminal to transition the DRX operation and stop (or deactivate) the measurement/measurement reporting, or to change (e.g., increase or decrease) the DRX configuration parameters or the parameters for the configuration of the measurement/measurement reporting.

The preference information may be transmitted in form of a field parameter of an RRC layer control message, a MAC CE message, or a physical layer uplink control channel. When the preference information is transmitted using a MAC CE message, the MAC CE message may include an identifier of the corresponding serving cell or a BWP identifier, and in a MAC header (or sub-header) of the MAC CE message, a separate logical channel identifier (LCID) for the MAC CE through which the preference information is transmitted may be allocated and configured. In addition, a method of assigning a different logical channel identifier according to the corresponding preference information and distinguishing the preference information of the terminal through the logical channel identifier may be used.

Also, the control messages described above may be generated and transmitted in form of a physical layer, MAC layer, or RRC control message, even when not separately described.

The base station that has received the request for the preference information of the terminal described above or the signaling information on whether the function for the preference information is supported may transmit a response message thereto, configure the function according to the corresponding preference information, or transmit to the terminal a control message for changing configuration parameters for the related.

Through the WUS, GTS, or PDCCH_MonitSig described above, the base station (or cell) may control the physical layer monitoring operation of the terminal so as to satisfy the service requirements and reduce the power consumption of the terminal. The above-described physical layer monitoring operation may include monitoring or reception operation (demodulation or decoding process) for downlink physical channels or radio resources such as a physical downlink control channel (PDCCH), CORESET resources, reference signals, or a physical downlink shared channel (PDSCH).

In addition, when the terminal in the inactive state or the idle state of FIG. 3 performs the downlink channel monitoring operation according to the configured DRX cycle or paging occasions (POs), the ‘DRX cycle’ in the above description of the operations may be replaced by ‘PO’. That is, the above-described operations, offsets, or timers according to the WUS reception, the GTS reception, or the PDCCH_MonitSig reception may be calculated, started, or terminated based on the starting time point or the ending time point of the PO of the corresponding terminal.

The cell (or base station) of the present disclosure may refer to a road side unit (RSU), a radio remote head (RRH), a transmission point (TP), a transmission and reception point (TRP), or a gNB, in addition to the NodeB, the evolved NodeB, the base transceiver station (BTS), the radio base station, the radio transceiver, the access point, or the access node as the base station described in FIG. 1. It may also be referred to as a CU node or a DU node according to application of functional split.

Also, the terminal of the present disclosure may refer to an Internet of Thing (IoT) device, a mounted module/device/terminal, or an on board device/terminal, in addition to the terminal, the access terminal, the mobile terminal, the station, the subscriber station, the mobile station, the mobile subscriber station, the node, or the device as the UE described in FIG. 1.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. An operation method of a terminal for reducing power consumption, the operation method comprising:
receiving, by a physical layer of the terminal, a wake-up signal (WUS) from a base station;
notifying, by the physical layer of the terminal, the reception of the WUS to a medium access control (MAC) layer of the terminal;
performing, by the physical layer of the terminal, a downlink physical layer monitoring operation for a preconfigured time period from a time point of the reception of the WUS; and
when the preconfigured time period expires, stopping, by the physical layer of the terminal, the downlink physical layer monitoring operation.

2. The operation method according to claim 1, wherein the WUS is received in a slot just before an on-duration period of a discontinuous reception (DRX) operation of the terminal or at a preconfigured time point earlier by a preconfigured offset than a reference time point.

3. The operation method according to claim 2, wherein the reference time point is a starting time point of the on-duration period, an ending time point of the on-duration period, a starting time point of a sleep time, an ending time point of the sleep time, a starting time point of a DRX cycle, or an ending time point of the DRX cycle.

4. The operation method according to claim 2, further comprising, when the WUS is not received at the preconfigured time point, stopping, by the physical layer of the terminal, the downlink physical layer monitoring operation for the preconfigured time period from the preconfigured time point.

5. The operation method according to claim 1, wherein the WUS is transmitted in at least one subcarrier and at least one symbol, transmitted as a physical layer downlink control channel (PDCCH), or transmitted using a specific field of downlink control information (DCI) of a PDCCH.

6. The operation method according to claim 1, wherein the downlink physical layer monitoring operation performed for the preconfigured time period from the time point of the reception of the WUS does not affect a DRX operation performed in the MAC layer of the terminal.

7. The operation method according to claim 1, further comprising transmitting a response message or a signal to the base station in response to the received WUS.

8. The operation method according to claim 1, wherein the downlink physical layer monitoring operation includes a monitoring and/or reception operation for a physical layer downlink control channel (PDCCH), a control resource set (CORESET) resource, a reference signal, and a physical layer downlink shared channel (PDSCH).

9. An operation method of a terminal for reducing power consumption, the operation method comprising:
receiving, by a physical layer of the terminal, a go-to-sleep signal (GTS) from a base station;
notifying, by the physical layer of the terminal, the reception of the GTS to a medium access control (MAC) layer of the terminal;
stopping a downlink physical layer monitoring operation for a preconfigured time period from a time point of the reception of the GTS; and
when the preconfigured time period expires, releasing, by the physical layer of the terminal, the stopping of the downlink physical layer monitoring operation.

10. The operation method according to claim 9, wherein the GTS is received in a slot just before an on-duration period of a discontinuous reception (DRX) operation of the terminal or at a preconfigured time point earlier by a preconfigured offset than a reference time point.

11. The operation method according to claim 10, wherein the reference time point is a starting time point of the on-duration period, an ending time point of the on-duration period, a starting time point of a sleep time, an ending time point of the sleep time, a starting time point of a DRX cycle, or an ending time point of the DRX cycle.

12. The operation method according to claim 9, wherein the GTS is transmitted in at least one subcarrier and at least one symbol, transmitted as a physical layer downlink control channel (PDCCH), or transmitted using a specific field of downlink control information (DCI) of a PDCCH.

13. The operation method according to claim 9, wherein the stopping of the downlink physical layer monitoring operation for the preconfigured time period from the time point of the reception of the GTS does not affect a DRX operation performed in the MAC layer of the terminal.

14. The operation method according to claim 9, further comprising, when the terminal transmits a scheduling request (SR) or a random access channel (RA) preamble, or when an SR/RA procedure is triggered, releasing the stopping of the downlink physical layer monitoring operation.

15. The operation method according to claim 9, further comprising transmitting a response message or a signal to the base station in response to the received GTS.

16. The operation method according to claim 9, wherein the downlink physical layer monitoring operation includes a monitoring and/or reception operation for a physical layer downlink control channel (PDCCH), a control resource set (CORESET) resource, a reference signal, and a physical layer downlink shared channel (PDSCH).

17. A connection reconfiguration method of a terminal for reducing power consumption, the connection reconfiguration method comprising:
performing a discontinuous reception (DRX) operation and a measurement and reporting operation according to connection configuration received from a base station;
transmitting preference information of the terminal to the base station when a predetermined condition is satisfied as a result of performing the DRX operation and the measurement and reporting operation; and
receiving a connection reconfiguration indication reflecting the preference information from the base station, and performing a DRX operation and a measurement and reporting operation changed based on the connection reconfiguration indication.

18. The connection reconfiguration method according to claim 17, wherein the predetermined condition includes at least one of a condition that no data exchange exists with the base station for a preconfigured time and an amount of data stored in a transmission buffer is less than or equal to a reference value, a condition that a measurement or measurement reporting related event does not occur for a preconfigured time, a condition that a measured value, a measurement reporting value, or a variation thereof for a preconfigured time satisfies a preconfigured condition, a condition that a result of reporting estimation of mobility status of the terminal satisfies a mobility management change condition of the terminal, and a condition that a user requests a change through manual configuration.

19. The connection reconfiguration method according to claim 17, wherein the preference information includes preference for a DRX cycle that is longer or shorter than a configured DRX cycle, preference for activation or deactivation of a measurement relaxation operation, information for releasing or requesting a low latency service, information for releasing or requesting a time tolerance service, preference for deactivation or release of the DRX operation, information indicating presence or absence of an additional power supply, information indicating a battery charge state, information for requesting to switch an active bandwidth part, preference for activation or deactivation of a wake-up signal (WUS) or a go-to-sleep signal (GTS), information for requesting to change a state of the terminal, and information for requesting to change configuration of a monitored control resource set (CORESET).

20. The connection reconfiguration method according to claim 17, wherein the preference information is transmitted to the base station in form of a radio resource control (RRC) layer control message, a medium access control (MAC) control element (CE), or a field parameter of a physical layer uplink control channel (PUCCH).
